(19) United States
(12) Patent Application Publication
(10) Pub. No.: US 2022/0366659 A1
(43) Pub. Date: Nov. 17, 2022

(54) Artificial Reality Resource Management

(71) Applicant: Meta Platforms Technologies, LLC, Menlo Park, CA (US)

(72) Inventors: John Jacob BLAKELEY, Bothell, WA (US); Jason Michael BATTLE, Bothell, WA (US); Jenny KAM, Seattle, WA (US)

(21) Appl. No.: 17/876,710

(22) Filed: Jul. 29, 2022

Related U.S. Application Data
(60) Provisional application No. 63/349,724, filed on Jun. 7, 2022.
(60) Provisional application No. 63/348,600, filed on Jun. 3, 2022.
(60) Provisional application No. 63/287,669, filed on Dec. 9, 2021.
(60) Provisional application No. 63/272,817, filed on Oct. 28, 2021.

(51) Int. Cl. G06T 19/00; G06T 7/70; G06F 1/3212

(52) U.S. Cl. CPC G06T 19/006; G06T 7/70; G06F 1/3212

(57) ABSTRACT

Aspects of the present disclosure are directed to an artificial reality (XR) power system defining transitions between power modes of an artificial reality device according to a set of transition triggers. Additional aspects of the present disclosure are directed to predicting how much time will be required to charge a battery from its current state to a full state. Further aspects of the present disclosure are directed to dynamically displaying virtual object elements. Yet further aspects of the present disclosure are directed to dynamically altering a display of a virtual object based on a detected overlap.

### CROSS REFERENCE TO RELATED APPLICATIONS

This application claims priority to U.S. Provisional Application Nos. 63/272,817 filed Oct. 28, 2021, titled “Artificial Reality Power Switching Model,” 63/287,669 filed Dec. 9, 2021, titled “Predicting Battery Charging Times,” 63/348,600 filed Jun. 3, 2022, titled “Dynamic Virtual Object Elements,” and 63/349,724 filed Jun. 7, 2022, titled “Dynamic Display Alterations for Overlapping Virtual Objects.” Each patent application listed above is incorporated herein by reference in their entireties.

### BACKGROUND

In an artificial reality environment, some of the objects that a user can see and interact with are virtual objects, which can be representations of objects generated by a computer system. Devices such as head-mounted displays (e.g., smart glasses, VR/AR headsets), mobile devices (e.g., smartphones, tablets), projection systems, “cave” systems, or other computing systems can present an artificial reality environment to the user, who can interact with virtual objects in the environment using body gestures and/or controllers. Some of the objects that a user can also interact with are real (real-world) objects, which exist independently of the computer system controlling the artificial reality environment. For example, a user can select a real object and add a virtual overlay to change the way the object appears in the environment.

Artificial reality devices generally have a number of systems such as a display, various user and location tracking systems, networking systems, audio systems, resource tracking systems, etc. However, artificial reality devices also generally have limited power supplies and must produce limited heat. While some artificial reality devices may have options to enable or disable certain systems at certain times, they tend to not have sufficient power savings and/or disable too many systems when a user would want them.

Many battery-powered devices have information regarding charging “time-to-full.” Such information typically takes the form of a notification or resides in a pulldown menu window on the home screen of the device and is populated upon the plug-in of a charging cable or, if wireless charging is supported, upon device placement on an inductive charging mat. Similarly, if the device was designed along with a docking solution, placing it on the charging dock will also trigger reporting of the time-to-full if the feature is indeed supported by the device software.

Knowing the time-to-full offers some useful application possibilities. As one example, the user can leverage this information to augment their daily activities and schedule according to when their battery is full. They might delay departure from their home until the battery is full and ready to go and, knowing in advance how much time remains until that happens, would be able to inform friends, family, colleagues, or others of their anticipated arrival time to some event or gathering. Along similar lines, a user might set an alarm for a nap based on how long they'd have to wait for their battery to be ready at full. Another use could be as part of an implementation of intelligent overnight charging, where the device initially charges the battery up to a level that's less deleterious to battery health (e.g., 80%) then waits to top off the remaining 20% in time for an expected usage event. However, existing time-to-full predictions tend to be inaccurate, resulting in a poor user experience.

Artificial reality systems have grown and popularity with users, and this growth is predicted to accelerate. Some artificial reality environments include virtual object displays. However, conventional virtual object implementations often include unexpected virtual object behavior. For example, depth and scale can be challenging to perceive in artificial reality, and therefore users may not accurately resolve a virtual object's location in the artificial reality environment. As another example, overlaps between virtual objects are not effectively mitigated, which can cause poor display behavior and user perception. Further, user interactions with the virtual object can cause frustrations when a user does not have an accurate perception, such as moving and placing the virtual object, input at control element of the virtual object, and other interactions.

### SUMMARY

Aspects of the present disclosure are directed to an artificial reality (XR) power system defining transitions between power modes of an artificial reality device according to a set of transition triggers. The power modes can include a low power standby mode, a glance mode where only a portion of the display is used, and an active mode where all the artificial reality device's systems are enabled. The transition triggers to move between these modes can include a user wake action, a notification received action, an assistant action, a notification selection action, a home gesture action, an all notifications dismissed action, a timeout action, and a lock action. A state machine can define which mode the artificial reality device is currently in and which of these transition triggers cause the artificial reality device to transition to which next mode.

Aspects of the present disclosure are directed to predicting how much time will be required to charge a battery from its current state to a full state. Charging a battery typically involves two stages, a first stage where constant current (“CC”) is applied and a second stage where constant voltage (“CV”) is applied. The transition between the CC and CV stages for a Li-ion battery is typically around when the battery is 80%-85% charged (depending on the specific battery characteristics). A static formula can be used, based on a linear relationship between charging current, capacity, and state-of-charge, to compute the time it will take to go from a current charge level to the CC/CV transition point (assuming the current state-of-charge level is before the CC/CV transition point). In contrast, the charging time in the CV phase is based on an exponentially decreasing current, which itself depends on temperature and battery age effects on battery impedance. Due to this nonlinear response, it is necessary to develop an empirical model based on temperature and battery age in order to accurately predict the CV time. Using experimental testing results, the CC/CV transition point can be determined and data points for the charge times for the CV stage at target temperatures, for given battery ages, can be computed. Interpolating between these data points, the charge time for the CV phase can be computed for an arbitrary battery temperature and age. The battery charge timing system can then use the formula for computing the remaining time in the CC stage (if any) and the empirical model for computing the remaining time in the CV stage (with a timer to remove any time already passed through the CV stage) to compute an overall time to full charge.

Aspects of the present disclosure are directed to dynamically displaying virtual object elements. A virtual object manager can display a virtual object to a user in an artificial reality (XR) environment. The user may select the virtual object, for example via user gaze input or any other suitable input. Upon receiving the selection, the virtual object manager can dynamically display virtual object elements for the selected virtual object. Example virtual object elements include virtual object chrome elements (e.g., buttons, images, or other suitable interface or control elements), a virtual object surface indicator (e.g., a shadow on a proximate two-dimensional surface), and any other suitable virtual object elements. In some implementations, the virtual object manager can detect a two-dimensional surface proximate to (nearby) the selected virtual object and dynamically display the virtual object surface indicator along the nearby surface. For example, the surface can be a two-dimensional surface and the displayed virtual object surface indicator can be a two-dimensional area projected onto the two-dimensional surface.

Aspects of the present disclosure are directed to dynamically altering a display of a virtual object based on a detected overlap. Implementations can display a first virtual object and a second virtual object in an artificial reality (XR) environment to a user. An overlap manager can detect whether the first virtual object and second virtual object are overlapping. In some implementations, at least one of the virtual objects can be engaged by the user and is moveable by input from the user when engaged. When an overlap is detected, the overlap manager can alter the display of one or both of the virtual objects to display an overlap indicator. In some implementations, as the overlap persists over time, the overlap manager can alter the display of the overlap indicator. An overlap timer can be defined that, upon expiration, causes one or more of the overlapping virtual objects to be dynamically moved. For example, when the duration of time that the virtual objects are overlapping meets the overlap timer, the overlap manager can dynamically move one or both of the overlapping virtual objects.

### BRIEF DESCRIPTION OF THE DRAWINGS

FIG. 1 is an example of a user's field of view through an artificial reality device in standby mode.

FIG. 2 is an example of a user's field of view through an artificial reality device in glance mode.

FIG. 3 is an example of a user's field of view through an artificial reality device in active mode.

FIG. 4 is a diagram of a state machine used in some implementations for controlling which mode is the current mode for an artificial reality device and what events cause the artificial reality device to transition to other modes.

FIG. 5 is an example of a charging profile of a typical Li-ion battery.

FIG. 6 is an example of the voltage and current applied during the charge of a Li-ion battery.

FIG. 7 is an example of experimental results for the constant voltage stage of charging a Li-ion battery, for a given temperature, depending on battery age.

FIG. 8 is an example of two graphs.

FIG. 9 is a flow diagram illustrating a process used in some implementations for deriving an empirical model of a constant voltage stage of a battery charge, with temperature and cycle count independent variables.

FIG. 10 is a flow diagram illustrating a process used in some implementations for continuously computing the time to a full battery charge in a device with a battery empirical model.

FIG. 11 depicts a system diagram of components for dynamically displaying virtual object elements.

FIG. 12 depicts visual diagrams of example virtual object element(s) and dynamic behavior in response to user input.

FIG. 13 is a flow diagram illustrating a process 300 used in some implementations for dynamically displaying virtual object elements.

FIG. 14 depicts a diagram of an artificial reality environment with overlapping virtual objects.

FIG. 15 depicts diagrams of an artificial reality environment with adjacent virtual objects.

FIG. 16 depicts a diagram of an artificial reality environment with an engaged virtual object that overlaps with a displayed virtual object.

FIG. 17 depicts a diagram of an artificial reality environment with dynamic movement of a displayed virtual object.

FIG. 18 depicts a diagram of an artificial reality environment with adjacent virtual objects.

FIG. 19 depicts a diagram of an artificial reality environment with a displayed virtual object placed along a surface.

FIG. 20 depicts a diagram of an artificial reality environment with an engaged virtual object moved along a surface.

FIG. 21 is a flow diagram illustrating a process used in some implementations for dynamically altering a display for a virtual object based on a detected overlap.

FIG. 22 is a block diagram illustrating an overview of devices on which some implementations of the present technology can operate.

FIG. 23 is a block diagram illustrating an overview of an environment in which some implementations of the present technology can operate.

### DESCRIPTION

Aspects of the present disclosure are directed to a model defining actions of an artificial reality (XR) power system for transitioning an artificial reality device between power modes according to a set of transition triggers. Wearable devices, such as artificial reality devices, often have limited power supplies and must produce limited amounts of heat. Systems on such devices, such as position tracking and display, take up a large amount of power, and it would be beneficial if a system could turn these off without significant degradation in user experience. An interaction model with multiple power modes, each having differing systems enabled and with appropriately triggered transitions between these modes, can reduce power consumption and heat output, while providing a beneficial user experience.

The power modes can include a standby mode, a glance mode, and a active mode. The standby mode can be where the artificial reality device only outputs audio, while the display and associated systems (e.g., eye tracking, 6 DoF sensors, cameras, etc.) are turned off. The glance mode can be where only a portion of the display is used to display minimized notifications of received events while turning on a low-power eye tracking system that can determine whether a user's gaze is on the notification. The active mode can be where all the artificial reality device's systems are enabled.

There are various transition triggers to move between the power modes. A user wake action trigger can be where a particular user action is detected such as shaking a digital wristband, pressing a wake button, or moving the artificial reality device in a particular pattern—such as with a double nod. A notification received action trigger can be where the artificial reality device receives a notification of an event such as a message having been received, a timer going off, a system event occurring, a location having bene reached, etc. An assistant action trigger can be where the user speaks a wake-word for a digital personal assistant application. A notification selection action trigger can be where a user's gaze is detected to have been on a displayed notification for a threshold amount of time. A home gesture action trigger can be where a user makes a particular hand gesture mapped to a gesture to open a home menu (e.g., a middle finger pinch or index finger swipe up gesture). An all notifications dismissed action trigger can be where it is detected at the user has dismissed all pending notifications. A timeout action trigger can be where it is detected the user has not provided any of a set of input types for a threshold amount of time. A lock action trigger can be where a particular user action is detected such as shaking a digital wristband, pressing a lock button, or moving the artificial reality device in a particular pattern—such as with a double sideways shake.

From the standby mode, a notification received or an assistant action triggers can move the artificial reality system to the glance mode. From the standby mode, a user wake action trigger can move the artificial reality system to the active mode. From the glance mode, a notification selection, a user wake action, or a home gesture triggers can move the artificial reality system to the active mode. The XR power system can move the artificial reality system back to the standby mode, from the glance mode, when all notifications are dismissed or when the timeout occurs; and can go back to the standby mode, from the active mode, when a lock action is performed or when the timeout occurs.

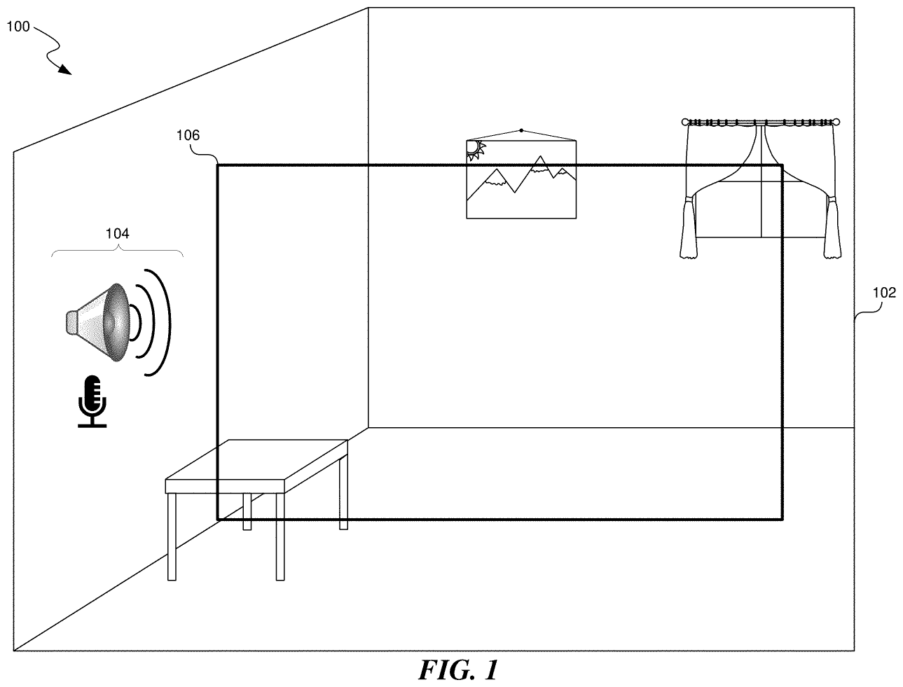

FIG. 1 is an example 100 of a user's field of view through an artificial reality device in standby mode. Example 100 illustrates a real-world space 102 with the portion of the real-world space 102 that a user is viewing through an artificial reality device and over which the artificial reality device can display content (i.e., the field of view) illustrated as rectangle 106. In the standby mode, the display can be turned off, so no virtual content is displayed in the field of view 106. In the standby mode, audio systems (e.g., a digital personal assistant, auditory notifications, music player, etc.) may be enable, which are illustrated as audio icons 104 (not visible to a user).

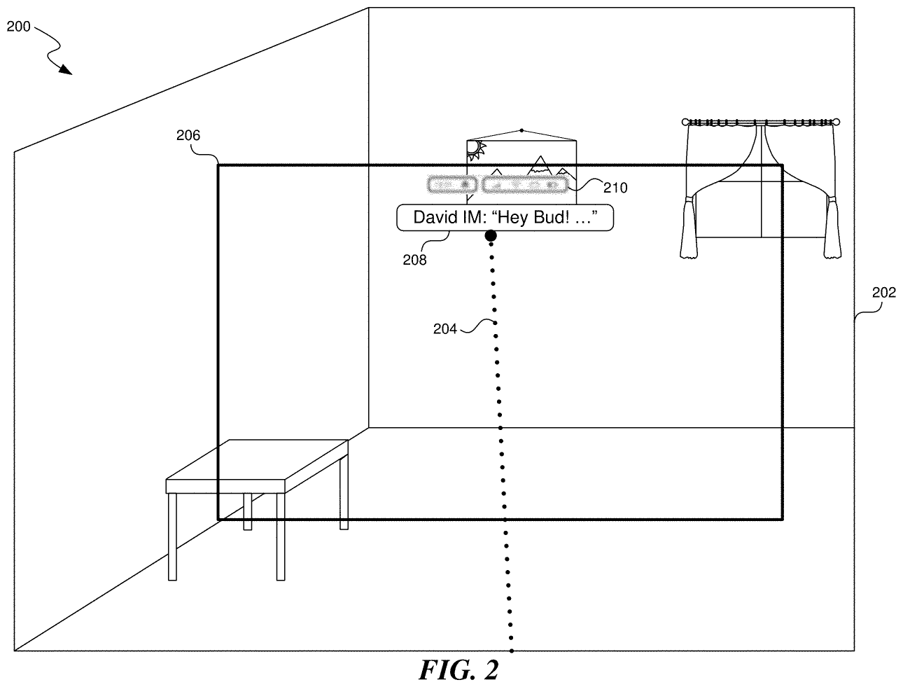

FIG. 2 is an example 200 of a user's field of view through an artificial reality device in glance mode. Example 200 illustrates a real-world space 202 with the portion of the real-world space 202 that a user is viewing through an artificial reality device and over which the artificial reality device can display content (i.e., the field of view) illustrated as rectangle 206. In the glance mode, the top portion of the display can be turned on, allowing the artificial reality device to provide system virtual content 210 (e.g., time, power status, network connectivity, etc.) and current notifications, such as notification 208. In the glance mode, a user's gaze may be tracked in so far as whether it is directed at a displayed notification, where in example 200 the user's gaze is illustrated by dotted line 204. When the user's gaze 204 lingers on a notification for a threshold amount of time, the artificial reality device can transition to an active mode.

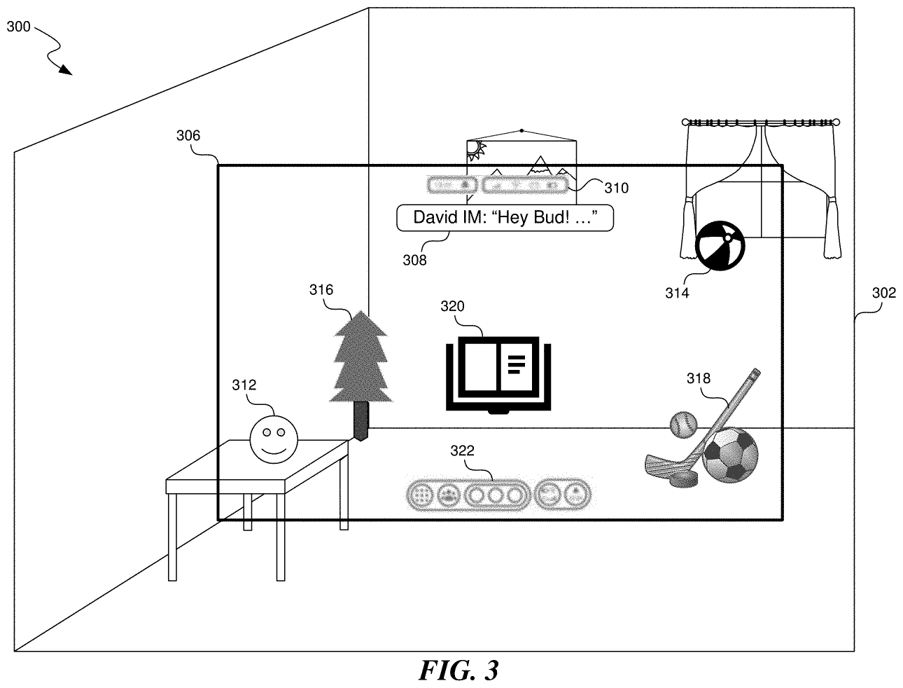

FIG. 3 is an example 300 of a user's field of view through an artificial reality device in active mode. Example 300 illustrates a real-world space 302 with the portion of the real-world space 302 that a user is viewing through an artificial reality device and over which the artificial reality device can display content (i.e., the field of view) illustrated as rectangle 306. In the active mode, the entire display area can be active, allowing the artificial reality device to display the system events 310 and notifications 308 from example 200, along with other virtual objects such as minimized virtual objects (e.g., virtual objects that can be iconic representations that can be maximized to show additional content), such as glints 312 and 314; world-locked virtual objects, such as virtual objects 316 and 318; body-locked virtual objects, such as virtual object 320; and system menus, such as system menus 322.

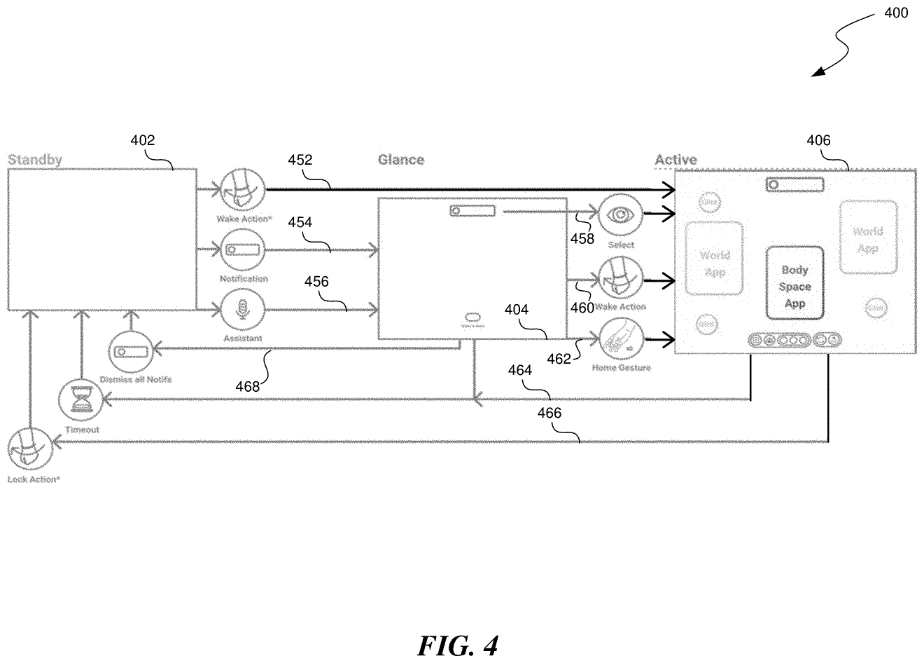

FIG. 4 is a diagram of a state machine 400 used in some implementations for controlling which mode is the current mode for an artificial reality device and what events cause the artificial reality device to transition to other modes. In some implementations, a process can be performed, e.g., by an artificial reality device operating system, artificial reality environment controller (i.e., “shell” application), or third-party application, to run the state machine 400 transitioning between states and activating the systems corresponding to a current mode and deactivating systems that do not correspond to the current mode.

The state machine 400 includes three states: standby state 402 (also referred to as a “low power state”), glance state 404 (also referred to as a “moderate power state”), and active state 406 (also referred to as a “full-feature state”). It will be understood that the names of these states are labels and other names could be similarly used. The standby state 402 is a state whereby minimal power is being consumed by an artificial reality device by virtue of disabling one or more of: a display system, an eye tracking system, a body tracking system, a device position tracking system, an environment mapping system, etc. The standby state 402 may include having active sound systems, networking systems, resource management systems, etc. In the standby state 402, for example, a user may be able to interact with a digital personal assistant (or otherwise provide voice commands) or receive sound-based notifications.

The glance state 404 is a state whereby a moderate amount of power is being consumed by an artificial reality device while providing some display services. In the glance state 404, a display system (or at least a portion of it for showing notification) and an eye tracking system are enabled along with the sound systems, networking systems, resource management systems, etc. In the glance state 404, other systems remain disabled such as the device position tracking system, body tracking system, environment mapping system, etc. In the glance state 404, for example, a user may be able to receive and view notifications of events and interact with a digital personal assistant, while the artificial reality device consumes only a moderate amount of power. In some implementations, a hand tracking system is also enabled in the glance state 404. In some implementations, the glance state 404 is configured to provide only non-invasive notifications, e.g., by only allowing notifications at the edge of the user's field of view.

The active state 406 is a state whereby the artificial reality device provides full services (though some systems may be idle when not being used or may be cycled between power and idle states). Thus, in the active state 406, each of the display system, eye tracking system, body tracking system, device position tracking system, environment mapping system, sound systems, networking systems, resource management systems, etc. can be enabled. In the active state 406, for example, a user can interact with virtual objects displayed via the display screen (in both a body-locked and world-locked manner), move about while the device is tracked in six-degrees of freedom (6 DoF), access social resources, interact with digital representations of other people, work with the digital personal assistant, or perform any other interaction provided by the artificial reality device.

When in the standby state 402, a notification event 454 or an assistant activation event 456 are transition triggers that can cause the artificial reality device to go into the glance state 404. The notification event 454 can be when a notification arrives via a networking source (e.g., an incoming message, social media activity, etc.) or an on-system event occurs (e.g., an alarm goes off, a power level threshold is reached, a network becomes available, etc.) The assistant activation event 456 can be when the artificial reality device recognizes an assistant wake word. Also, when in the standby state 402, a wake action 452 can be a transition trigger that can cause the artificial reality device to go into the active state 406. The wake action 452 can be a physical action that is mapped to waking up the artificial reality device having been identified. In some implementations, the artificial reality device includes or is associated with one or more companion devices, such as a separate compute device, a digital wristband, or digital ring. Pressing various buttons on the artificial reality device or companion device can be mapped as the wake action 452 or various motion patterns (e.g., IMU patterns) of the artificial reality device or companion device can be mapped as the wake action 452. For example, a double sideways wrist shake of the digital wristband can be the wake action 452.

When in the glance state 404, a notification select event 458, the wake action 460 (which can be the same as the wake action 452), or a home gesture event 462 are transition triggers that can cause the artificial reality device to go into the active state 406. The notification select event 458 can be when a user selects a presented notification, such as by speaking a command to select the notification or having her gaze (now being tracked in the glance state) linger on the notification for a threshold amount of time. The home gesture event 462 can be when the artificial reality device recognizes a hand gesture mapped to going to the active mode (or mapped to taking an action in the active mode such as opening a home menu). An example of such a gesture could be the user performing a pinch between her thumb and middle finger, but other gestures could have a similar mapping. Also, when in the glance state 404, an all notifications dismissed action 468 or a timeout event 464 can be transition triggers that can cause the artificial reality device to go back to the standby state 402. The all notifications dismissed action 468 can occur when the user has dismissed the last notification queued to be displayed in the glance mode. The timeout event 464 can occur when no user input, or no user input of a set of user input types (e.g., selecting a notification, speaking a command, etc.), has occurred for a threshold amount of time.

When in the active state 406, the time out event 464 or a lock action 466 can be transition triggers that can cause the artificial reality device to go back to the standby state 402. The lock action 466 can be identifying various buttons on the artificial reality device or companion device, mapped as the lock action 466, having been pressed or various motion patterns of the artificial reality device or companion device can be mapped as the lock action 466. In some cases, the lock action 466 can be the same as the wake action 452/460. In some implementations, the lock action 466, though not shown in state machine 400 as a path from the glance state to the standby state, can also cause this transition.

Aspects of the present disclosure are directed to predicting how much time will be required to charge a battery from its current state to a full state. Charging a battery typically involves two stages, a first stage where constant current (“CC”) is applied and a second stage where constant voltage (“CV”) is applied. Thus, the battery charge timing system can make an accurate time-to-full prediction if the CC/CV transition point can be determined and a time for each of the CV and CC stages can be computed.

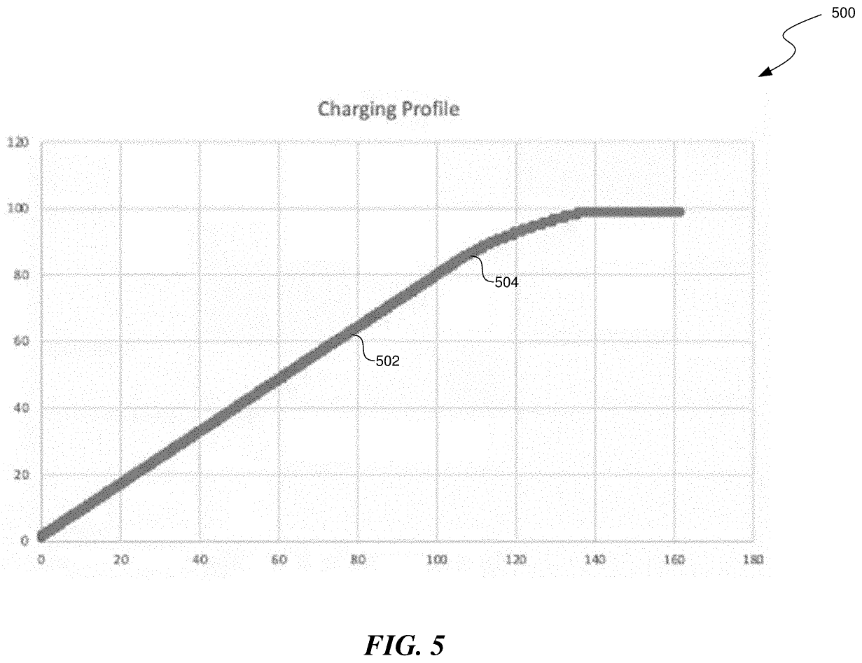

The CC/CV transition point is generally static, independent of temperature and battery age (within 3-4% charge level, with minor variation). Thus, the CC/CV transition point can be empirically measured for a battery type and set as a static variable. As an example, the battery charge timing system can set the CC/CV transition point at about 80% battery life. In other implementations, for a accuracy improvement, the CC/CV transition point can also be modeled based on experimental data. Additional details on determining a CC/CV transition point are provided below in relation to block 504 of FIG. 5.

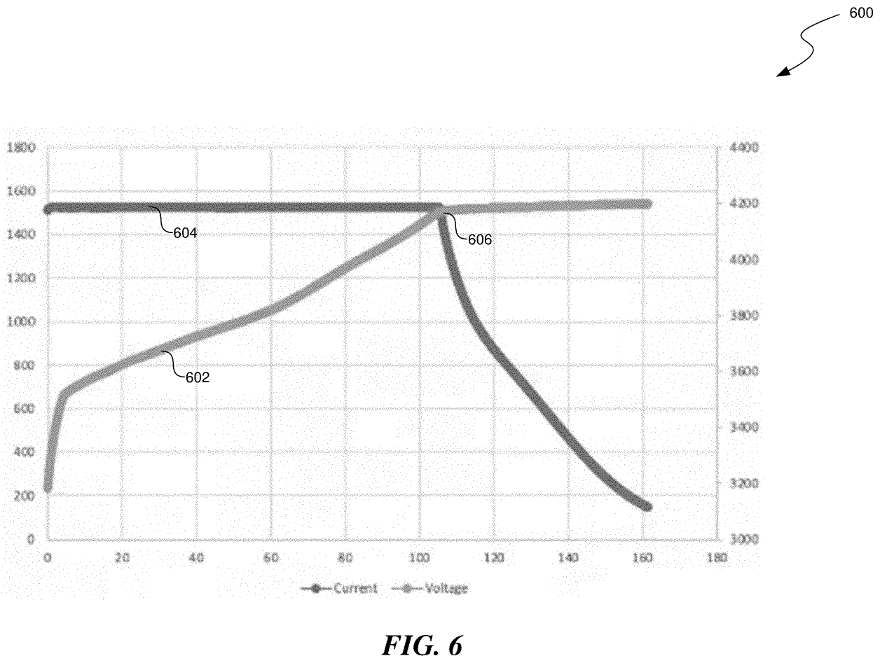

The time for the CC stage is independent of temperature and battery age, and thus the battery charge timing system can compute it by applying a formula. This formula (in units of minutes) can be CC Time=((((cv_soc_transition-soc_now)/100)*full_charge_capacity)/current)*60, where the cv_soc_transition is the CC/CV transition point, the soc_now is the current battery state-of-charge, the full_charge_capacity is the battery capacity, and the current is the charging current being applied in the CC stage. Additional details on computing a CC stage portion of a charging time are provided below in relation to block 606 of FIG. 6.

A time for the CV stage (i.e., the time required to charge the battery from the CC/CV transition point to full charge) depends on a current temperature and an age of the battery. The battery charge timing system can generate a model for the CV stage using experimental testing that generates data points as the charge times for the CV stage at given temperatures, for given battery ages. Thus, the battery charge timing system can determine a set of data points for each of a set of fixed temperatures, and using linear interpolation, can compute a general formula for any given temperature (within the characterized bounds). The result the battery charge timing system can produce is an empirical model of the CV stage with temperature and battery cycle count as independent variables. Additional details on generating an empirical model of the CV stage of charging a battery point are provided below in relation to FIG. 5.

The battery charge timing system can then use the formula for computing the remaining time in the CC stage (if any) and the empirical model for computing the remaining time in the CV stage (with a timer to remove any time already passed through the CV stage) to compute an overall time to full charge. Additional details on applying the CC stage formula and CV stage empirical model to compute an overall charge time are provided below in relation to FIG. 6.

FIG. 5 is an example 500 of a charging profile of a typical Li-ion battery. The x-axis in example 500 shows time while the y-axis shows state of charge (SOC) as a percentage. As is illustrated by line 502, the charging profile is generally linear during the first portion of the charge (during the constant current stage), until the SOC reaches about 83% at point 504, when line 502 becomes a logarithmic curve (during the constant voltage stage).

FIG. 6 is an example 600 of the voltage and current applied during the charge of a Li-ion battery. Example 600 includes a line 602 representing a voltage as the battery's response to the charge current and a line 604 representing a current level applied during the charging cycle. Example 600 illustrates the CC/CV transition point 606, before which the current line 604 is substantially flat (the constant current stage) and after which the voltage line 604 is substantially flat (the constant voltage stage).

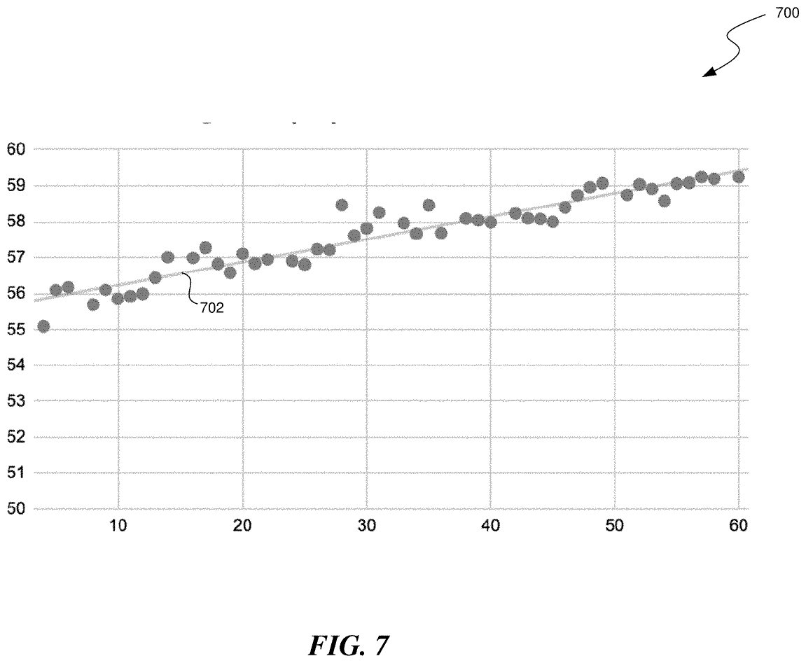

FIG. 7 is an example 700 of experimental results for the constant voltage stage of charging a Li-ion battery, for a given temperature, depending on battery age. In example 700, the x-axis represents battery age (cycle count) while the y-axis represents the number of minutes it took for the constant voltage stage to complete. A line 702 is fit to the measured data points.

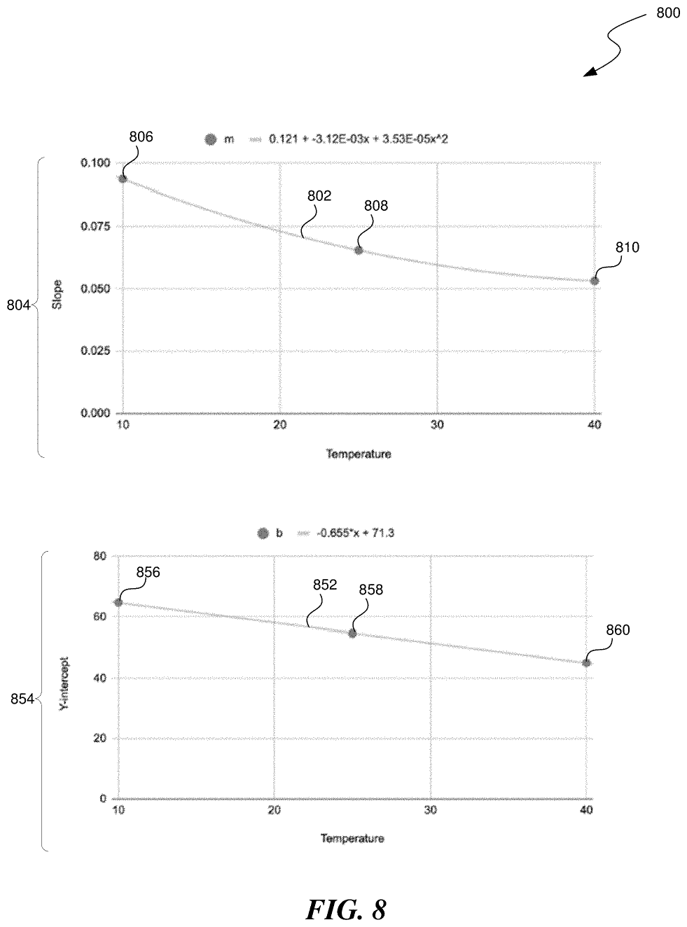

FIG. 8 is an example 800 of two graphs. Graph 804 which is a fit to the measured slopes (on the y-axis) of the constant voltage stage timing lines, such as line 702, at each of a give temperature (on the x-axis). For example, if three test sets were performed, the slope of the line for the fit to the 10 degree data set is shown at 806, the slope of the line for the fit to the 25 degree data set is shown at 808, and the slope of the line for the fit to the 40 degree data set is shown at 810. The line 802 is a fit to these data points. Similarly for y-intercepts, graph 854 which is a fit to the measured y-intercepts (on the y-axis) of the constant voltage stage timing lines, such as line 702, at each of a give temperature (on the x-axis). For example, if three test sets were performed, the y-intercept of the line for the fit to the 10 degree data set is shown at 856, the y-intercept of the line for the fit to the 25 degree data set is shown at 858, and the y-intercept of the line for the fit to the 45 degree data set is shown at 860. The line 852 is a fit to these data points.

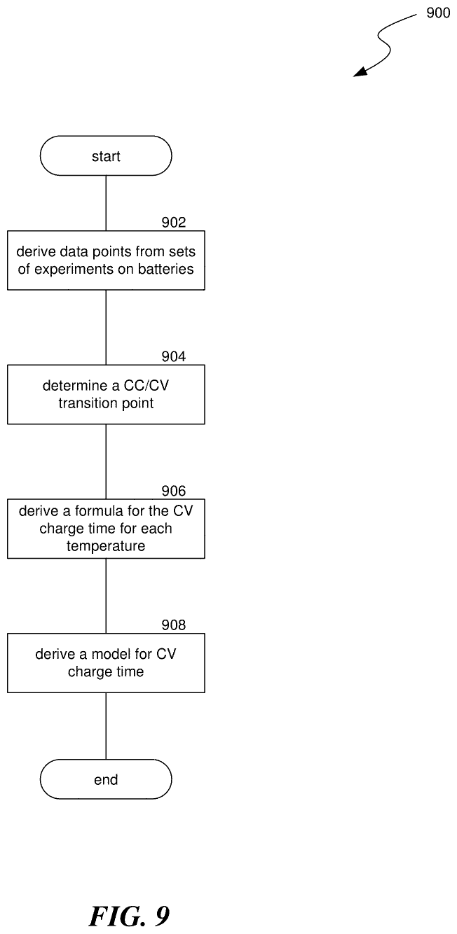

FIG. 9 is a flow diagram illustrating a process 900 used in some implementations for deriving an empirical model of a constant voltage stage of a battery charge, with temperature and cycle count independent variables. Process 900 can be performed on a computing system modeling a battery or battery type, with the resulting empirical model being useable by that or other systems to project a constant voltage stage charge time.

At block 902, process 900 can derive data points from sets of experiments on batteries. Each experiment set can have a defined constant temperature (different from the other sets) with an increasing battery cycle count over the course of the experiment. The experiments can be performed across typical operating temperatures of a battery, such as at 10 degrees C., 25 degrees C., and 40 degrees C. An example of the results from one such experiment set is provided in FIG. 7 (which are the points after the CC/CV transition point, determined in step 904).

At block 904, process 900 can determine a CC/CV transition point. This can be a point in the charging cycle at which the current changes from a previous constant value to an exponentially decaying value, while the voltage becomes constant. Such a CC/CV transition point is illustrated in FIG. 6.

At block 906, process 900 can derive a formula for the CV charge time for each temperature, given a cycle number. Process 900 can accomplish this by determining the coefficients of a line that best fits a set of CV stage data points of a particular temperature, as measured at block 902. In some cases, multiple sets of measurements can be performed on various batteries at each temperature, and the coefficients can be averaged across the sets for a given temperature. For example, the 25 degrees C. set, the function describing CV time can be y=0.0655 c+54.75, for the 10 degrees C. set the line can be y=0.0937 c+64.8, and for the 40 degrees C. set the line can be y=0.0532 c+45.15 (where c is a battery age, in number of cycles).

At block 908, process 900 can derive a model for CV charge time by plotting the slope coefficient from each temperature (as shown in graph 804 of FIG. 8) and plotting the y-intercept coefficient from each temperature (as shown in graph 454 of FIG. 8) and fitting a function to each. Thus, process 900 can perform a curve fit on the slope and y-intercept plots to create a function that describes how they change with respect to temperature. The slope function can be fit to a second-order polynomial whereas the y-intercept can be linear. Both values tend to increase at colder temperatures, which supports the notion that higher cell impedance at cold will lead to increased CV times since that phase begins earlier due to larger voltage drop from open-circuit circuit voltage. In one example, the slope (m) and y-intercept (b) values for a particular battery are calculated from the following functions, where t is temperature: m=3.53e\hat{ }−5*t\hat{ }2-3.12e\hat{ }−3*t+0.121 and b=−0.655*t+71.3. The overall function f(t, c) in this example, where t is a temperature and c is a battery age (cycles) then is f(t, c)=(3.53e−5*t\hat{ }2-3.12e−3*t+0.121)c+(−0.655*t+71.3).

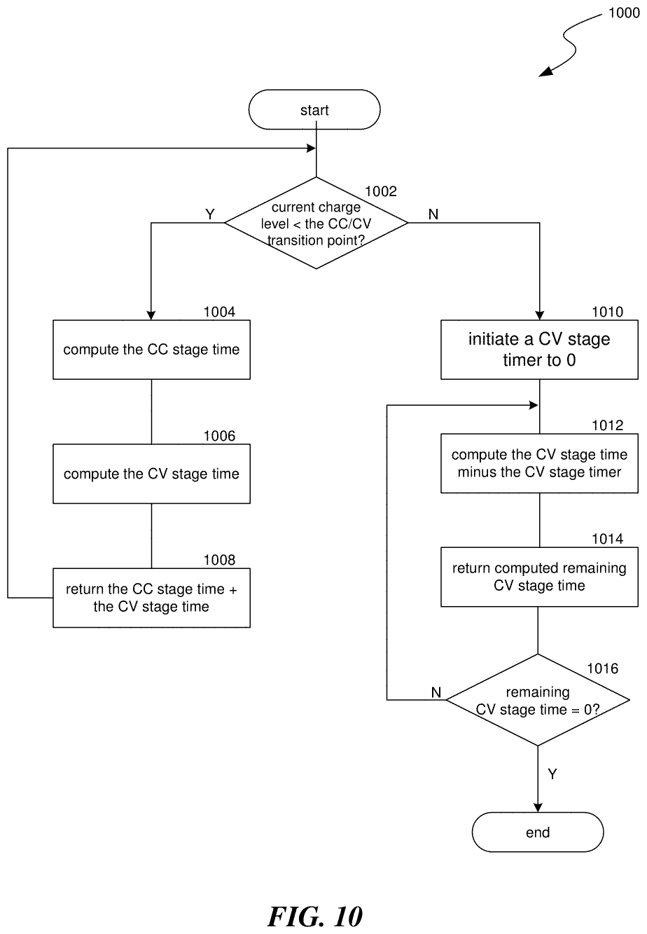

FIG. 10 is a flow diagram illustrating a process 1000 used in some implementations for continuously computing the time to a full battery charge in a device with a battery empirical model created using process 900.

At block 1002, process 1000 can determine whether the current state-of-charge level is less than the CC/CV transition point (e.g., as determined at block 904 for the model of the battery used by the current device). If so, process 1000 can proceed to block 1004 and if not, process 1000 can proceed to block 1010.

At block 1004, process 1000 can compute the CC stage time. Process 1000 can apply the following formula (which is not reliant on temperature or battery age) to compute the CC stage time: CC Time=((((cv_soc_transition−soc_now)/100)*full_charge_capacity)/current)*60, where the cv_soc_transition is the CC/CV transition point, the soc_now is the current battery state-of-charge level, the full_charge_capacity is the battery capacity, and the current is the charging current being applied in the CC stage.

At block 1006, process 1000 can compute the CV stage time based on a battery cycle count and current temperature. Process 1000 can accomplish this by applying the model computed for the current battery by process 500, which takes a current battery age in cycles and temperature.

At block 1008, process 1000 can add the CC stage time from block 1004 to the CV stage time from block 1006. Process 1000 can return this value as the current time to full charge and continue the charging process by returning to block 1002.

At block 1010, process 1000 can initialize a CV stage timer to 0. This timer can automatically increment to track how far through the CV stage the charging process has progressed.

At block 1012, process 1000 can compute the CV stage time based on a battery cycle count and current temperature (similarly to block 1006) then subtract the current value of the CV stage timer initialized at block 1010. If the result of this subtraction is less than zero, the result can be set to zero instead. At block 1014, process 1000 can return the remaining CV stage time computed at block 1012 as the current time to full charge.

At block 1016, process 1000 can determine whether the time to full charge computed at block 1012 is zero. If not, process 1000 can continue the charging process returning to block 1012; if so, the charging is complete and process 1000 can end.

Implementations dynamically display virtual object elements for a selected virtual object according to user input and nearby surfaces. A virtual object manager can display a virtual object to a user in an XR environment. The user may select the virtual object, for example via tracked user gaze input, tracked hand/body input, trackpad input, controller input, or any other suitable user input. Upon receiving the selection, the virtual object manager can dynamically display virtual object elements for the selected virtual object. Example virtual object elements include virtual object chrome elements (e.g., buttons, images, or other suitable interface or control elements), a virtual object surface indicator (e.g., a shadow on a proximate two-dimensional surface), and any other suitable virtual object elements.

In some implementations, the virtual object manager can detect a two-dimensional surface proximate to (nearby) the selected virtual object and dynamically display the virtual object surface indicator along the nearby surface. For example, the surface can be a two-dimensional surface and the displayed virtual object surface indicator can be a two-dimensional area projected onto the two-dimensional surface. In some implementations, a proximity criteria (e.g., threshold distance) can be defined for the virtual object such that a surface within the XR environment that meets the proximity criteria can be detected as a proximate surface.

In some implementations, an orientation for the proximate surface can be detected, and the surface indicator can be displayed according to the detected orientation. For example, the orientation can include the proximate surface's spatial coordinates within the XR environment. In some implementations, an orientation for the proximate surface relative to the virtual object can be detected. For example, the relative position of proximate surface given a reference point of the virtual object (e.g., reference coordinate, area, or volume) can be detected. In some implementations, the surface indicator can be displayed as a two-dimensional surface area along the detected proximate surface according to the detected orientation. For example, a spatial transformation and/or mapping transformation can be applied to map the virtual object (e.g., three-dimensional volume) to the two-dimensional surface.

In some implementations, when a virtual object is moved in an XR environment, the proximate surface (at which a surface indicator for a virtual object is displayed) can change. For example, prior to virtual object movement, a first proximate surface (e.g., surface within a threshold distance of the virtual object) can be a horizontal surface and after virtual object movement a second proximate surface can be a vertical surface. In this example, when the virtual object is nearby the first proximate surface, the surface indicator can be a horizontal surface area projection on the first proximate surface and when the virtual object is nearby to the second proximate surface, the surface indicator can be vertical surface area projection on the second proximate surface. Implementations can alter the surface area indicator for a virtual object depending on the orientation for the surface detected to be proximate to the virtual object.

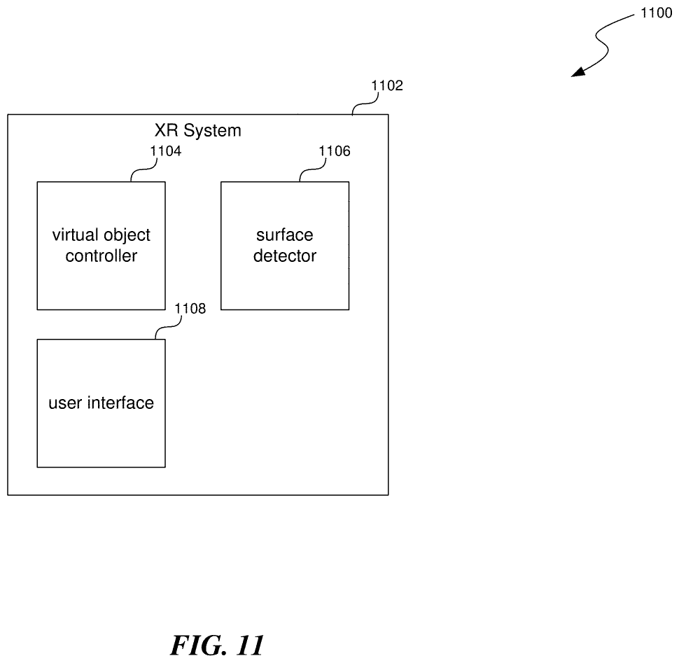

FIG. 11 depicts a system diagram of components for dynamically displaying virtual object elements. System 1100 includes XR system 1102, virtual object controller 1104, surface detector 1106, and user interface 1108. XR system 1102 can display an XR environment to a user. User interface 1108 can receive input from the user, such as tracked user gaze input, tracked hand/body input, trackpad input, controller input, or any other suitable user input. For example, XR system 1100 can include device(s) that receive user input, such as sensors (e.g., cameras), one or more hand-held controllers, a trackpad, any other suitable input device, or any combination thereof. User interface 1108 can receive signals from the device(s) and track the user input.

Implementations of XR system 1102 display a virtual object to the user within the XR environment such that input received by user interface 1108 can cause interactions with the displayed virtual object. For example, user gaze input (e.g., gaze ray), user hand/body input (e.g., a ray cast from a user's hand/wrist), or any other suitable input can control a cursor (e.g., displayed cursor or invisible cursor) within the XR environment to select the displayed virtual object. In response to a user selection for the virtual object, virtual object controller 1104 can dynamically display virtual object elements for the selected virtual object.

For example, a virtual object chrome can be displayed in response to the input, such as buttons, images, or suitable interface or control elements. In some implementations, the virtual object chrome can be displayed when the user input selects/intersects with a predetermined portion of the virtual object (e.g., bottom half, top half, side half, or any other suitable predetermined portion). The virtual object chrome elements can be used to configure the virtual object (e.g., minimize/glint the virtual object, engage the virtual object, configure the display, control the behavior, or any other suitable configuration).

In another example, a virtual object surface indicator can be displayed in response to user input that selects the virtual object, such as a shadow or outline that is displayed on a proximate two-dimensional surface. In some implementations, surface detector 1106 can detect a two-dimensional surface proximate to (nearby) the selected virtual object. For example, a proximity criteria (e.g., threshold distance) can be defined for the virtual object such that a surface (e.g., two-dimensional panel, two-dimensional surface of a three-dimensional volume, etc.) within the XR environment that meets the proximity criteria can be detected as a proximate surface.

The proximate two-dimensional surface can be a surface of an additional element within the XR environment, such as other virtual objects, displayed (or invisible) virtual surfaces, real-world objects or surfaces mapped to the XR environment, or any other suitable elements. Real-world objects or surfaces can be mapped to the XR environment using scanning techniques, such as a three-dimensional mapping, spatial mapping, or other suitable technique to map a real-world space to an XR environment. Real-world objects and/or surfaces of a threshold size can be automatically recognized and mapped to the XR environment. In this example, a virtual object from the XR environment that is not present in the real-world can be proximate to a mapped real-world surface, and a virtual object surface indicator from such a virtual object can be displayed at the mapped real-world surface.

In some implementations, distance(s) between a reference point for the virtual object and a reference point for one or more candidate surface(s) can be determined (e.g., Euclidean distance), and the determined distance(s) can be compared to the proximity criteria to detect a proximate surface. Once a proximate surface is detected, virtual object controller 1104 can dynamically display the virtual object surface indicator along the proximate surface. For example, the surface can be a two-dimensional surface and the displayed virtual object surface indicator can be a two-dimensional area projected onto the two-dimensional surface. In some implementations, a transformation can be performed that includes mapping a three-dimensional volume for the virtual object to a two-dimensional area on the proximate surface. The surface indicator can be displayed along the proximate surface in any other suitable manner.

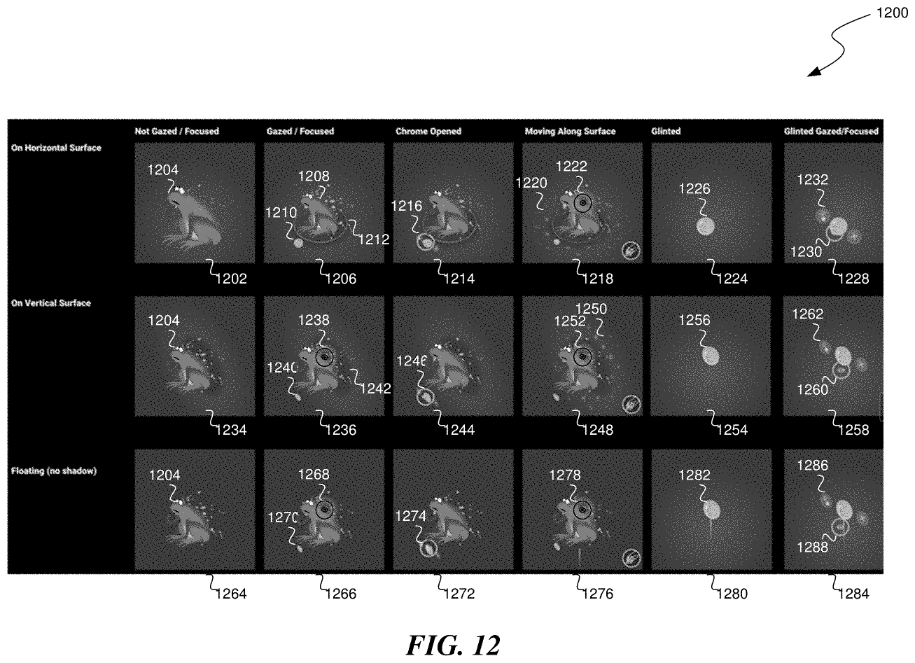

FIG. 12 depicts visual diagrams of example virtual object element(s) and dynamic behavior in response to user input. Illustration 1200 includes diagrams 1202, 1206, 1214, 1218, 1224, 1228, 1234, 1236, 1244, 1248, 1254, 1258, 1264, 1266, 1272, 1276, 1280, and 1284. Diagrams 1202, 1206, 1214, 1218, 1234, 1236, 1244, 1248, 1264, 1266, 1272, and 1276, include virtual object 1204. For example, virtual object 1204 can be a three-dimensional volume, or any other suitable virtual object displayed to a user in an XR environment. Diagrams 1224 and 1228 include glint 1226, diagrams 1254 and 1258 include glint 1256, and diagrams 1280 and 1284 include glint 1282. For example, glints 1226, 1256, and 1282 can be a minimized version of virtual object 1204, such as a two-dimensional representation or icon, displayed to a user in an XR environment.

Diagrams 1202, 1206, 1214, and 1218 demonstrate virtual object 1204 proximate to a horizontal surface (e.g., a table in an XR environment), diagrams 1234, 1236, 1244, and 1248 demonstrate virtual object 1204 proximate to a vertical surface (e.g., a wall in an XR environment), and diagrams 1264, 1266, 1272, and 1276 demonstrate a floating virtual object 1204 (e.g., no detected proximate surface). Similarly, diagrams 1224 and 1228 demonstrate glint 1226 proximate to a horizontal surface, diagrams 1254 and 1258 demonstrate glint 1256 proximate to a vertical surface, and diagrams 1280 and 1284 demonstrate a floating glint 1282.

Turning to diagrams 1202, 1206, 1214, and 1218, diagram 1202 depicts virtual object 1204 proximate to a horizontal surface. The user may select virtual object 1204 via any suitable user input technique (e.g., gaze, tracked motion, trackpad, etc.). Diagram 1206 depicts the user selecting virtual object 1204 via cursor 1208, controlled by the user input. For example, virtual object chrome 1210 and surface indicator 1212 can be dynamically displayed according to the user selection. In some implementations, surface indicator 1212 is displayed along the horizontal surface depicted in diagram 1206 based on the horizontal surface meeting a proximity criteria for virtual object 1204. As illustrated by diagram 1206, when the proximate surface detected nearby virtual object 1204 is horizontal, surface indicator 1212 is projected as a horizontal surface area.

Diagram 1214 depicts the selection of virtual object chrome 1210 by cursor 1216. In some implementations, selection of virtual object chrome 1210 (e.g., buttons, images, or other suitable interface or control elements) can dynamically display one or more additional elements of virtual object chrome 1210. For example, the additional elements of virtual object chrome 1210 (e.g., buttons, etc.) can be used to configure virtual object 1204, such as minimize the virtual object into a glint version, engage the virtual object for movement/placement, configure the display of the virtual object, and the like. Diagram 1218 depicts an engaged virtual object 1204 that is moved along the proximate horizontal surface. For example, cursor 1222 can engage virtual object 1204 (e.g., via an engagement gesture, via the virtual object chrome, etc.) and user input can move the virtual object along the depicted horizontal surface. Once virtual object 1204 is engaged, surface symbols 1220 can be dynamically displayed along the horizontal surface to aid the user's movement/placement of the virtual object.

Turning to diagrams 1224 and 1228, diagram 1224 depicts glint 1226, or a minimized version (e.g., two-dimensional version) of virtual object 1204 displayed to a user in an XR environment. For example, virtual object 1204 can be minimized by the user (e.g., via the virtual object chrome, an input gesture, etc.) or the XR system (e.g., after reaching a computing resource criteria, screen display density, or other criteria). Diagram 1228 depicts cursor 1230, controlled by user input, which selects glint 1226, and glint chrome 1232 can be dynamically displayed according to the selection. In some implementations, glint chrome 1232 can be similar to virtual object chrome 1210.

Turning to diagrams 1234, 1236, 1244, and 1248, diagram 1248 depicts virtual object 1204 proximate to a vertical surface. Diagram 1236 depicts a user selecting virtual object 1204 via cursor 1238, controlled by the user input. For example, virtual object chrome 1240 and surface indicator 1242 can be dynamically displayed according to the user selection. In some implementations, surface indicator 1242 is displayed along the vertical surface depicted in diagram 1236 based on the vertical surface meeting a proximity criteria for virtual object 1204. As illustrated by diagram 1236, when the proximate surface detected nearby virtual object 1204 is vertical, surface indicator 1242 is projected as a vertical surface area.

Diagram 1244 depicts the selection of virtual object chrome 1240 by cursor 1246. In some implementations, selection of virtual object chrome 1240 can dynamically display one or more additional elements of virtual object chrome 1240. For example, the additional elements of virtual object chrome 1240 (e.g., buttons, etc.) can be used to configure virtual object 1204, such as minimize the virtual object into a glint version, engage the virtual object for movement/placement, configure the display of the virtual object, and the like. Diagram 1248 depicts an engaged virtual object 1204 that is moved along the proximate vertical surface. For example, cursor 1252 can engage virtual object 1204 and user input can move the virtual object along the depicted vertical surface. Once virtual object 1204 is engaged, surface symbols 1250 can be dynamically displayed along the vertical surface to aid the user's movement/placement of the virtual object.

Turning to diagrams 1254 and 1258, diagram 1254 depicts glint 1256. Diagram 1258 depicts cursor 1260, controlled by user input, which selects glint 1256, and glint chrome 1262 can be dynamically displayed according to the selection. In some implementations, glint chrome 1262 can be similar to glint chrome 1232.

Turning to diagrams 1264, 1266, 1272, and 1276, diagram 1264 depicts virtual object 1204 in a floating orientation (e.g., not proximate to a surface). Diagram 1266 depicts a user selecting virtual object 1204 via cursor 1268, controlled by the user input. For example, virtual object chrome 1270 can be dynamically displayed according to the user selection. In some implementations, a surface indicator is not displayed for a virtual object in a floating orientation.

Diagram 1272 depicts the selection of virtual object chrome 1270 by cursor 1274. In some implementations, selection of virtual object chrome 1270 can dynamically display one or more additional elements of virtual object chrome 1270. For example, the additional elements of virtual object chrome 1270 (e.g., buttons, etc.) can be used to configure virtual object 1204, such as minimize the virtual object into a glint version, engage the virtual object for movement/placement, configure the display of the virtual object, and the like. Diagram 1276 depicts an engaged virtual object 1204 that is moved in the floating orientation. For example, cursor 1278 can engage virtual object 1204 and user input can move the virtual object in the XR environment.

Turning to diagrams 1280 and 1284, diagram 1280 depicts glint 1282. Diagram 1284 depicts cursor 1288, controlled by user input, which selects glint 1282, and glint chrome 1286 can be dynamically displayed according to the selection. In some implementations, glint chrome 1286 can be similar to glint chrome 1232.

Implementation that dynamically display a surface indicator of a virtual object at a proximate surface (e.g., the vertical surface or horizontal surface depicted in FIG. 12) can provide improved user perception of the virtual object in an XR environment, for example by improving the user's depth and/or scale perspective. In some implementations, the surface indicator also aids in the movement/placement of a virtual object along a proximate surface.

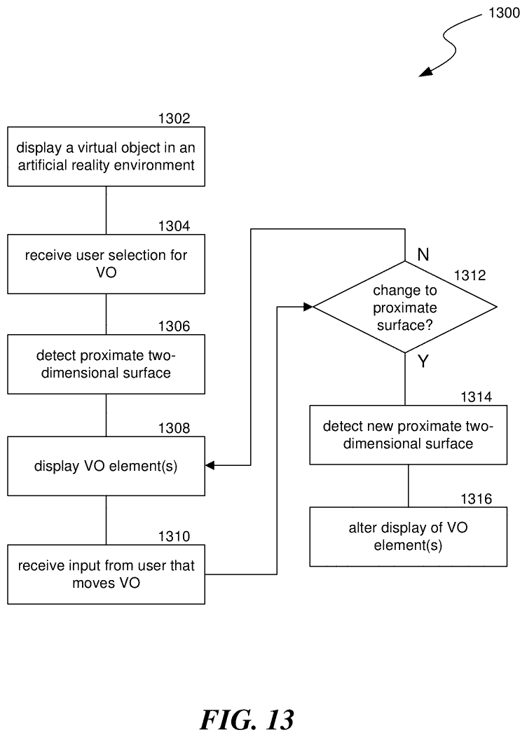

FIG. 13 is a flow diagram illustrating a process 1300 used in some implementations for dynamically displaying virtual object elements. In some implementations, process 1300 can be performed in response to user input at a virtual object displayed in an XR environment. For example, process 1300 can dynamically display virtual object elements for a selected virtual object and implement changes to the display of the virtual object (e.g., movements) and/or the virtual object elements (e.g., virtual object chrome, virtual object surface indicator, etc.).

At block 1302, process 1300 can display a virtual object in an XR environment. For example, the XR environment can be displayed to a user via an XR system. A virtual object (e.g., two-dimensional panel, three-dimensional volume, etc.) can be displayed at a given location within the XR environment.

At block 1304, process 1300 can receive, from a user, a selection for the displayed virtual object. For example, the user can select the displayed virtual object using a tracked user input, such as tracked gaze input, controller input, tracked hand/body movement, trackpad input, any other suitable user input, or any combination thereof. In some implementations, the virtual object is selected according to a displayed cursor controlled by the user input.

At block 1306, process 1300 can detect a two-dimensional surface proximate to the selected virtual object within the XR environment. For example, one or more additional elements can be present in the XR environment along with the selected virtual object. These additional elements can include additional virtual objects, displayed (or invisible) virtual surfaces, real-world objects or surfaces mapped to the XR environment, or any other suitable elements. Real-world objects or surfaces can be mapped to the XR environment using scanning techniques (e.g., depth sensing camera(s), LiDAR, three-dimensional mapping, spatial mapping, ML powered computer vision, etc.) to scan a real-world space that contains such objects or surfaces. Objects and/or surfaces of a threshold size (e.g., 1 square foot) can be automatically recognized in the generated scan. These real-world objects/surfaces can then be mapped to the XR environment such that virtual objects that are not present in the real-world can be proximate to the mapped real-world surfaces.

In some implementations, the detected two-dimensional surfaces can be a surface of a three-dimensional volume proximate to the selected virtual object. In some implementations, a proximity criteria (e.g., threshold distance) can be defined, and a proximate element (e.g., two-dimensional surface or surface of a three-dimensional volume) can be detected when the element is within the proximity criteria (e.g., within the threshold distance). Any other suitable technique for detecting a proximate element/surface can be implemented.

In some implementations, an orientation for the two-dimensional surface can be detected. For example, the orientation can include the two-dimensional surface's spatial coordinates within the XR environment. In some implementations, an orientation for the two-dimensional surface relative to the virtual object can be detected. For example, the relative position of the two-dimensional surface given a reference point of the virtual object (e.g., reference coordinate, area, or volume) can be detected. In some implementations, the relative orientation includes a defined angle or spatial transformation that maps the virtual object onto the two-dimensional surface.

At block 1308, process 1300 can display, in response to the selection, one or more virtual object elements for the selected virtual object, the virtual object elements including a virtual object chrome and/or a two-dimensional surface indicator. Example virtual object chrome includes buttons, control elements, interface elements, or other suitable display elements that achieve user interactions with the selected virtual object. Example surface indicators include a shadow, an outline, or any other suitable virtual object representation.

In some implementations, the two-dimensional surface indicator can be displayed as an area along the detected two-dimensional surface according to the detected orientation. For example, a spatial transformation and/or mapping transformation can be applied to map the virtual object (e.g., three-dimensional volume) to the two-dimensional surface.

At block 1310, process 1300 can receive user input that moves the virtual object to a new location in the XR environment. For example, the user can perform a gesture (e.g., pinch gesture) or other suitable input technique (e.g., double click, predetermined selection mechanism) to engage the displayed virtual object, and the engaged virtual object can be moved to a new location in the displayed XR environment according to user input (e.g., tracked gaze input, controller input, tracked hand/body movement, trackpad input, etc.)

At block 1312, process 1300 can determine whether there is change to the detected proximate surface. For example, virtual object movement can cause changes to the distances between the virtual object and additional elements within the XR environment (e.g., the detected proximate two-dimensional surface, other virtual objects/surfaces, other real-world objects/surfaces, etc.). A change to the proximate surface can be detected when the new location for the virtual object relative to the proximate surface no longer satisfies the proximity criteria (e.g., distance threshold).

When a change to the detected proximate surface is determined, process 1300 can progress to block 1314. When a change to the detected proximate surface is noted detected, process 1300 can loop back to block 1308. For example, the display of virtual object elements for the virtual object can remain until the virtual object is moved to a location that causes a change to the detected proximate surface.

At block 1314, process 1300 can detect a new proximate two-dimensional surface. For example, one or more relative distances between one or more additional elements (e.g., additional virtual objects, displayed (or invisible) virtual surfaces, real-world objects or surfaces mapped to the XR environment, etc.) can be compared to the proximity criteria. When an additional element meets the proximity criteria, a two-dimensional surface of the additional element can be detected as the new proximate two-dimensional surface.

In some implementations, an orientation for the new proximate two-dimensional surface can be detected. For example, the orientation can include the new proximate two-dimensional surface's spatial coordinates within the XR environment. In some implementations, an orientation for the new proximate two-dimensional surface relative to the new location for the virtual object can be detected. For example, the relative position of the new proximate two-dimensional surface given a reference point of the new location of the virtual object (e.g., reference coordinate, area, or volume) can be detected. In some implementations, the relative orientation includes a defined angle or spatial transformation that maps the virtual object at the new location onto the new proximate two-dimensional surface.

In some implementations, it can be detected that no additional element in the XR environment meets the proximity criteria. For example, the virtual object can be moved to a new location where no two-dimensional surface is proximate to the virtual object (e.g., the virtual object can be floating in the XR environment).

At block 1316, process 1300 can alter the display of one or more virtual object elements. For example, the display of the surface indicator can be dynamically altered such that the surface indicator is displayed along the new proximate surface and is no longer displayed at the previous proximate surface. In some implementations, the surface indicator can be displayed as an area along the new proximate surface according to the orientation detected for the new proximate surface. For example, a spatial transformation and/or mapping transformation can be applied to map the virtual object (e.g., three-dimensional volume) to the two-dimensional surface. In some implementations, no new surface indicator is displayed when no new proximate surface is detected.

Implementations can dynamically alter a display for a virtual object based on a detected overlap. Implementations can display a first virtual object and a second virtual object in an XR environment to a user. An overlap manager can detect whether the first virtual object and second virtual object are overlapping. For example, the boundaries (e.g., coordinates) for the virtual objects can be compared to determine whether any area/volume of the virtual objects intersect/overlap.

In some implementations, one of the virtual objects can be engaged by the user and is moveable by input from the user when engaged. For example, an engagement gesture/action by the user can engage the virtual object, and while engaged the virtual object can be moved by user input within the XR environment. In this example, an overlap can be caused by a user moving one of the virtual objects to overlap with another and/or an overlap condition can be mitigated by a user manually moving an overlapping virtual object. In another example, a virtual object can be automatically placed (e.g., by an application and/or an XR system) such that an overlap is generated.

When an overlap is detected, the overlap manager can alter the display of one or both of the virtual objects to display an overlap indicator. For example, the overlap indicator can be an outline that spans the overlapping portion, a mask/overlay that spans the overlapping portion, or any other suitable indicator. In some implementations, as the overlap persists over time the overlap manager can alter the display of the overlap indicator, such as by increasing a brightness, changing a display color, increasing the width of an outline, or any other suitable display change.

An overlap timer can be defined that, upon expiration, causes one or more of the overlapping virtual objects to be dynamically moved. For example, when the duration of time that the virtual objects are overlapping meets the overlap timer, the overlap manager can dynamically move one or both of the overlapping virtual objects. In this example, the user may move one of the overlapping virtual objects by engaging with the object and manually moving the object, or the overlap manager may dynamically move one of the overlapping objects upon expiration of the overlap timer.

Implementations also detect proximate surfaces near an engaged/selected virtual object and project a surface indicator onto the proximate surface. For example, a distance between the engaged/selected virtual object and surface can be determined, and when the distance meets a proximity criteria, a surface indicator can be displayed to increase the user's awareness about the relative locations of the virtual object and the surface in the XR environment. When a virtual object is engaged and a proximate surface is detected, implementations can also dynamically display surface symbols to aid the user in manually moving the engaged virtual object along the surface.

Implementations can also stick an engaged virtual object to a proximate surface. For example, when a user engages and moves a virtual object near a proximate surface, the user may intend to move the virtual object along the surface. Movement of the engaged virtual object can traverse the proximate surface such that the virtual object is pulled toward the surface during the movement. Implementations can define a threshold distance, velocity, or other suitable threshold(s) such that movement of the engaged virtual object way from the proximate surface that meets or exceeds the threshold(s) moves the virtual object away from the proximate surface (e.g., unsticks the virtual object from the proximate surface).

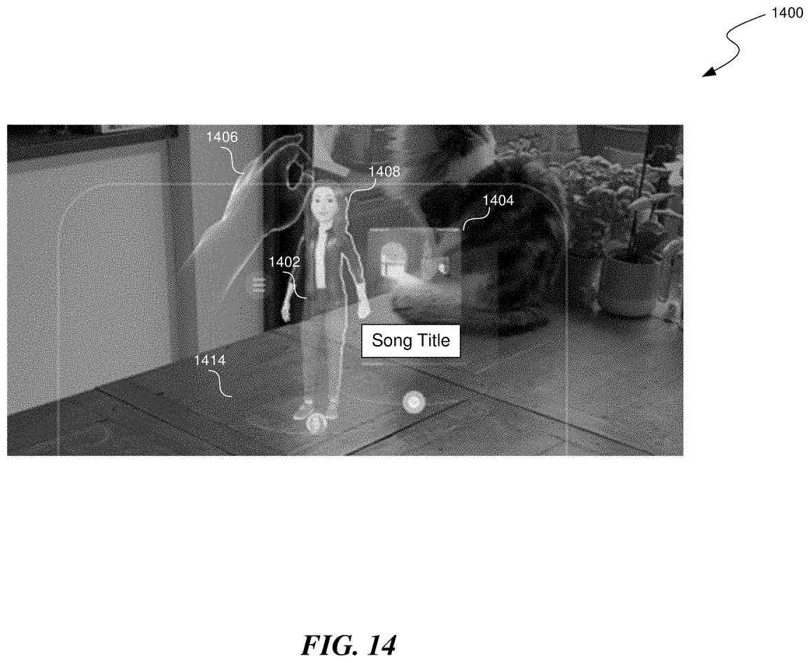

FIG. 14 depicts a diagram of an artificial reality environment with overlapping virtual objects. Diagram 1400 includes virtual objects 1402 and 1404, engagement indicator 1406, overlap indicator 1408, and surface 1414. In some implementations, the XR environment can include real-world surfaces that are mapped to the XR environment and virtual objects that are not present in the real-world. Real-world objects or surfaces can be mapped to the XR environment using scanning techniques, such as a three-dimensional mapping, spatial mapping, or other suitable technique to map a real-world space to an XR environment. Real-world objects and/or surfaces of a threshold size can be automatically recognized and mapped to the XR environment. In this example, a virtual object from the XR environment that is not present in the real-world can be proximate to a mapped real-world surface. In some implementations, surface 1414 can be a real-world surface mapped to the illustrated XR environment, such as the surface of a real-world table, and virtual objects 1402 and 1404 can be virtual objects no present in the real-world displayed relative to surface 1414.

In the illustrated example, virtual object 1402 is engaged by a user. For example, the user can perform a gesture (e.g., pinch gesture) or other suitable input technique (e.g., double click, predetermined selection mechanism) to engage the displayed virtual object, and the engaged virtual object can be moved to a new location in the displayed XR environment according to user input (e.g., tracked gaze input, controller input, tracked hand/body movement, trackpad input, etc.) Engagement indicator 1406 (which may or may not be displayed in the XR environment) demonstrates that virtual object 1402 is engaged by the user.

In some implementations, an XR system that displays the XR environment can receive input from the user, such as tracked user gaze input, tracked hand/body input, trackpad input, controller input, or any other suitable user input. For example, the XR system can include device(s) that receive user input, such as sensors (e.g., cameras), one or more hand-held controllers, a trackpad, any other suitable input device, or any combination thereof. Based on signals received from the device(s), the XR system can track the user input.

In the illustrated example, virtual object 1402 overlaps with virtual object 1404. For example, an overlap manager can detect the overlap between the virtual objects by comparing an area/volume and location within the virtual environment for each virtual object to detect whether the virtual objects 1402 and 1404 intersect at any locations. Upon detection of the overlap, the overlap manager can dynamically alter the display of one or more of virtual objects 1402 and 1404 to display overlap indicator 1408. In the illustrated example, the display of virtual object 1402 is altered to display overlap indicator 1408 as an outline that spans the overlapping region of the virtual object. Other suitable overlap indicators include a mask/overlay that spans the overlapping portion, altering the opaqueness/transparency of the overlapping portion, or any other suitable indicator. Overlap indicator 1408 can guide the user to place engaged virtual object 1402 at a location that does not overlap with virtual object 1404.

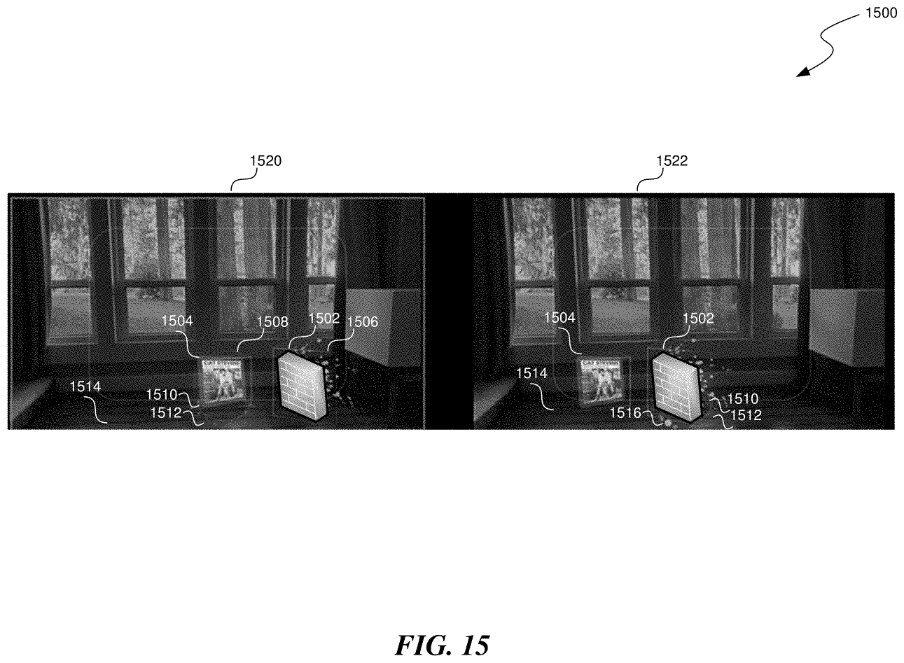

FIG. 15 depicts diagrams of an artificial reality environment with adjacent virtual objects. Diagram 1500 includes XR displays 1520 and 1522, virtual objects 1502 and 1504, boundary boxes 1506 and 1508, surface indicator 1510, surface symbols 1512, surface 1514, and virtual object chrome 1516. In XR display 1520, virtual object 1504 is engaged or selected by a user (e.g., selected via tracked gaze, tracked hand/body motion, etc.) Based on the engagement/selection, additional virtual object elements for virtual object 1504 can be displayed. For example, surface indicator 1510 can be displayed at surface 1514 (e.g., detected to be proximate to virtual object 1504). In another example, surface symbols 1512 can be displayed along surface 1514, for example, to aid the user's movement of virtual object 1504 along surface 1514.

In XR display 1522, virtual object 1502 is engaged or selected by a user. Based on the engagement/selection, additional virtual object elements for virtual object 1502 can be displayed. For example, surface indicator 1510 can be displayed at surface 1514 (e.g., detected to be proximate to virtual object 1502). In another example, surface symbols 1512 can be displayed along surface 1514, for example, to aid the user's movement of virtual object 1502 along surface 1514. In addition, virtual object chrome 1516 can be displayed based on the engagement/selection. For example, virtual object chrome 1516 can include buttons, images, or other suitable interface or control elements. The elements of virtual object chrome 1516 can be used to configure virtual object 1502, such as minimize the virtual object into a glint version (e.g., two-dimensional version or compressed version), engage the virtual object for movement/placement, configure the display of the virtual object, and the like.

In the illustrated example, diagrams 1520 and 1522 both display boundary boxes 1506 and 1508 around virtual objects 1502 and 1504. The boundary boxes can identify the volumes/areas that the virtual objects occupy in the XR environment. In some implementations, a boundary box can be displayed around a selected/engaged virtual object and any other virtual object within a threshold distance of the selected/engaged virtual object. In this example, the boundary boxes can aid the user in placing a virtual object to avoid an overlap.

In some implementations, an engaged virtual object that is moved so that it collides with a stationary virtual object can move the stationary virtual object to avoid an overlap. For example, engaged virtual object 1502 can be moved by user input until it collides with stationary virtual object 1504. The collision can be detected when the boundaries for the virtual objects intersect. Based on the collision, virtual object 1504 can be moved in the direction of the movement of virtual object 1502 (e.g., along surface 1514) to avoid an overlap.

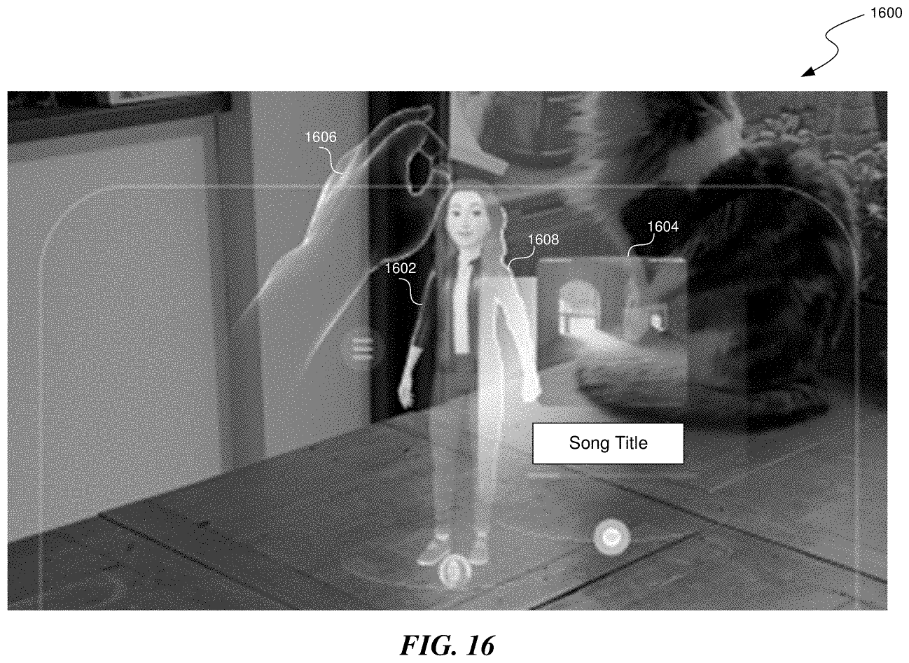

FIG. 16 depicts a diagram of an artificial reality environment with an engaged virtual object that overlaps with a displayed virtual object. Diagram 1600 includes virtual objects 1602 and 1604, engagement indicator 1606, and overlap indicator 1608. In the illustrated example, virtual object 1602 overlaps with virtual object 1604. Based on the detected overlap, an overlap manager can dynamically alter the display of one or more of virtual objects 1602 and 1604 to display overlap indicator 1608.

In the illustrated example, the display of virtual object 1602 is altered to display overlap indicator 1608 as an outline that spans the overlapping portion of the virtual object. In some implementations, as the overlap between the virtual objects is maintained, the overlap manager can alter the display of overlap indicator 1608. For example, overlap indicator 1608 is altered from an outline to an outline and an overlay/mask (here seen as a dimming effect) that spans the overlapping portion. Other suitable alterations to overlap indicator 1608 can include increasing a brightness, changing a display color, increasing the width of an outline, altering a mask/overlay, or any other suitable display change.

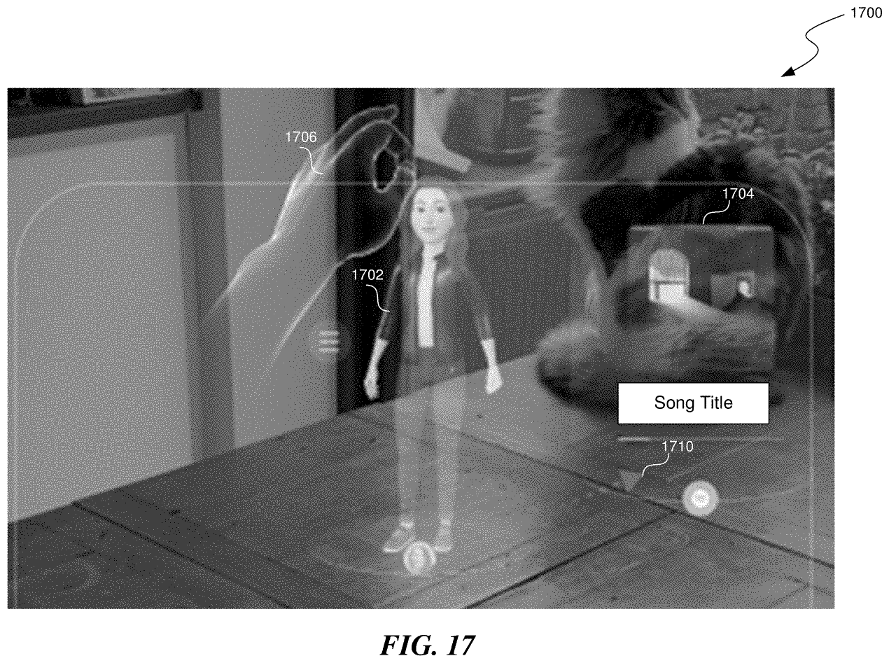

In some implementations, an overlap timer can be defined (e.g., 5 seconds, 10 seconds, 1 minutes, minutes, etc.) where, upon expiration of the overlap timer the overlap manager can dynamically move one or more of the overlapping virtual objects. FIG. 17 depicts a diagram of an artificial reality environment with dynamic movement of a displayed virtual object. Diagram 1700 includes virtual objects 1702 and 1704, engagement indicator 1706, and movement indicator 1710. FIG. 17 depicts locations for virtual objects 1702 and 1704 after dynamic movement by the overlap manager upon expiration of an overlap timer. For example, virtual objects 1702 and 1704 were overlapping virtual objects prior to expiration of an overlap timer and virtual objects 1702 and 1704 depict non-overlapping virtual objects after the overlap manager dynamically moves the virtual objects upon expiration of the overlap timer.

Movement indicator 1710 (illustrated for explanatory purposes but not displayed in the XR environment) demonstrates that the overlap manager has dynamically moved virtual object 1704 to eliminate the overlap between virtual objects. For example, because virtual object 1702 is engaged by the user (as illustrated by engagement indicator 1706) the overlap manager can dynamically move the non-engaged overlapping virtual object. In other implementations, upon expiration of an overlap timer an engaged virtual object can be dynamically moved, two overlapping virtual objects can be dynamically moved, or any other dynamic movement can be performed.

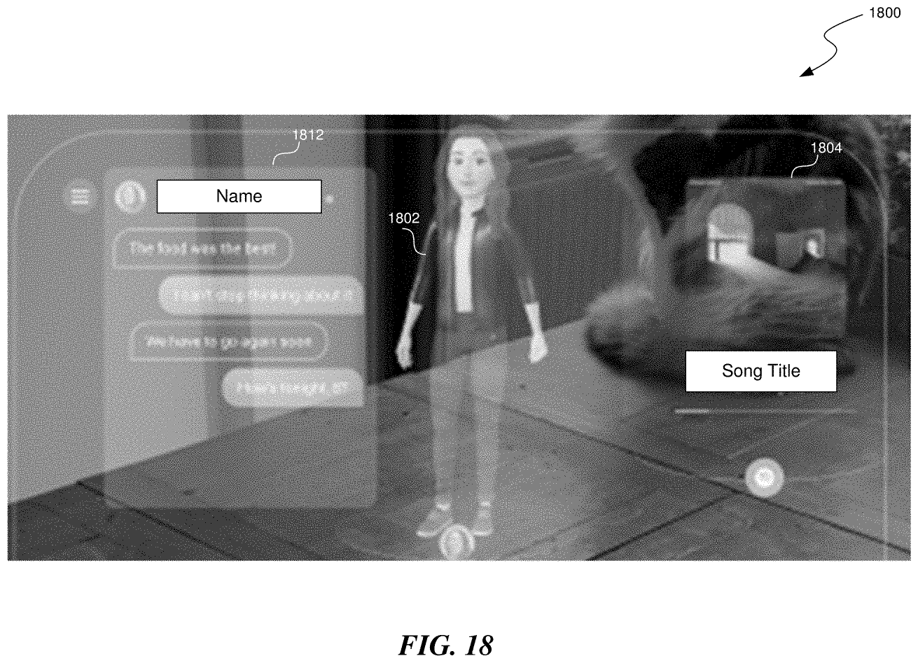

FIG. 18 depicts a diagram of an artificial reality environment with adjacent virtual objects. Diagram 1800 includes virtual objects 1802, 1804, and 1812. In the illustrated example, virtual object 1812 can be placed by a software application or the XR system at a location that does not overlap with virtual objects 1802 and 1804. In this example, the available volume in the XR environment permits placement of virtual object 1812 in a non-overlapping space.

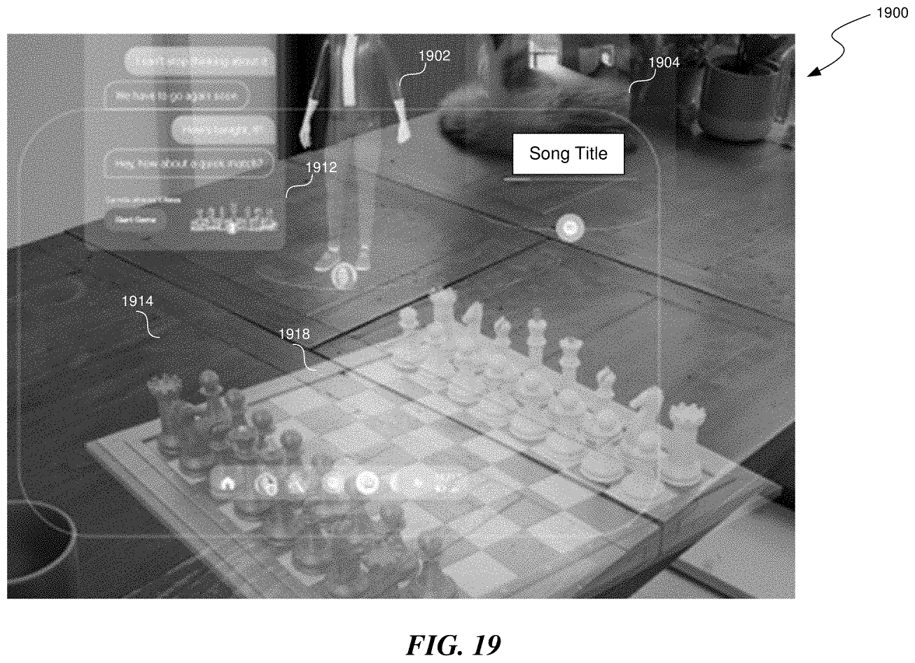

FIG. 19 depicts a diagram of an artificial reality environment with a displayed virtual object placed along a surface. Diagram 1900 includes virtual objects 1902, 1904, 1912, and 1918, and surface 1914. In the illustrated example, virtual object 1918 is placed by an application or the XR system at a location that meets a placement preference criteria for the virtual object. For example, virtual object 1918 is a board game and a placement preference criteria may define that virtual object 1918 be placed on a surface (e.g., surface 1914).

In this example, the placement of virtual object 1918 alters the XR environment in such a manner that two or more of virtual objects 1902, 1904, 1912 and/or 1918 may overlap. However, in this example completely reducing overlapping virtual objects may not be feasible due to the cumulative areas/volumes of the displayed virtual objects in relation to the surface of the table they are attached to. In some implementations, the overlap manager may permit overlapping virtual objects when the cumulative areas/volumes of the displayed virtual objects meet a criteria (e.g., threshold volume of a portion of the XR environment, such as a threshold percentage of available display space, threshold cumulative area/volume, etc.) In some implementations, a user can manually adjust the placement of virtual objects in such a condition.

In the depicted example, surface 1914 correspond to a real-world table mapped into the XR environment. Virtual object 1918 is not entirely located on surface 1914 (e.g., a portion of the virtual board game is hanging off the real-world table). In some implementations, when portions of virtual object 1918 fit on surface 1914 (e.g., a majority of the displayed surface area/volume) a remaining portion that does not fit can be permitted to float next to surface 1914.

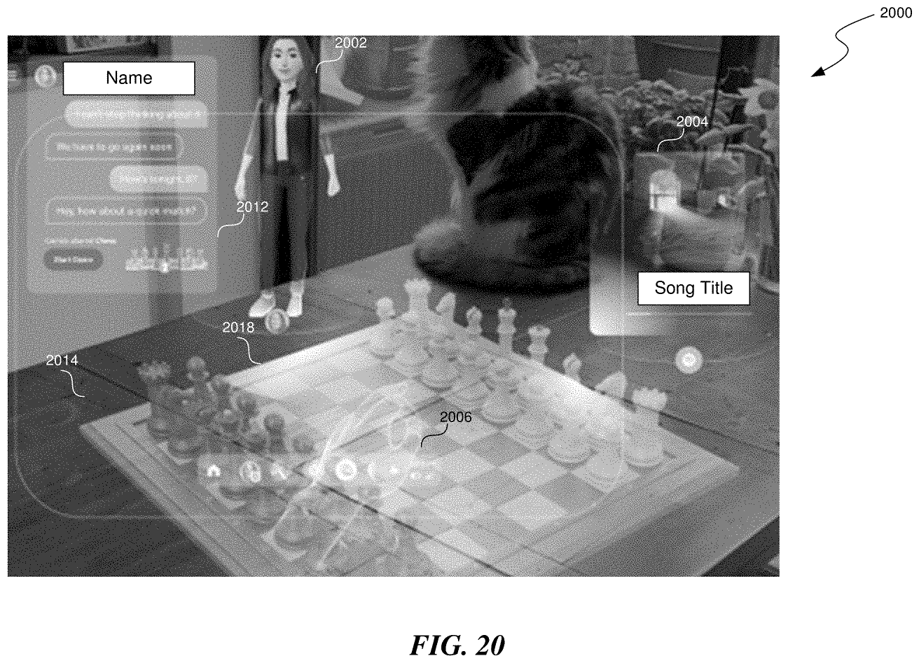

FIG. 20 depicts a diagram of an artificial reality environment with an engaged virtual object moved along a surface. Diagram 2000 includes virtual objects 2002, 2004, 2012, and 2018, engagement indicator 2006, and surface 2014. In the illustrated example, virtual object 2018 is engaged by a user (as depicted by engagement indicator 2006) and moved along surface 2014 until the boundary of the virtual object fits on surface 2014 (e.g., a real-world table). The overlap manager may permit two or more of virtual objects 2002, 2004, 2012, and 2018 to overlap due to the cumulative areas/volumes of the displayed virtual objects meeting a criteria.

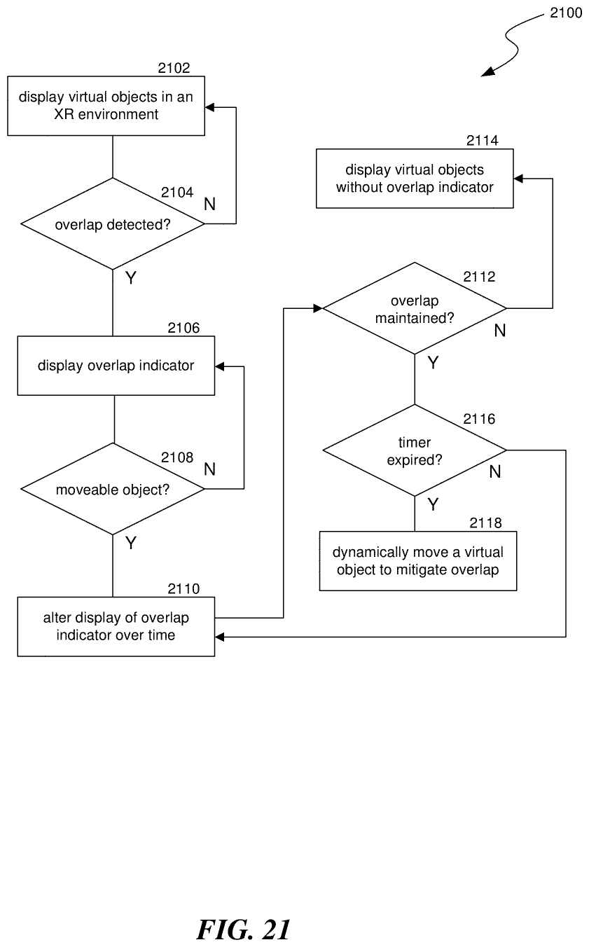

FIG. 21 is a flow diagram illustrating a process 2100 used in some implementations for dynamically altering a display for a virtual object based on a detected overlap. In some implementations, process 2100 can be performed in response to placement of a virtual object in an XR environment. For example, process 2100 can dynamically alter the display of one or more virtual objects by dynamically displaying an overlap indicator at a virtual object, dynamically changing the display of the overlap indicator over time, and/or dynamically moving a virtual object.

At block 2102, process 2100 can display a first virtual object and a second virtual object in the XR environment. The virtual objects can be three-dimensional volumes or two-dimensional areas. In some implementations, the XR environment is displayed to a user by an XR system. For example, the XR system can receive input from the user (e.g., via sensor(s), camera(s), hand-held controller(s), a trackpad, or other suitable input device) to interact with the first and second virtual objects.

In some implementations, the first virtual object can be engaged for movement by a user. For example, an engagement gesture or other suitable engagement technique can be received from the user that targets the first virtual objects such that the first virtual object is engaged. When engaged, the user can move and place the first virtual object.

At block 2104, process 2100 can determine whether an overlap between the first virtual object and the second virtual object is detected. For example, an area/volume and location within the virtual environment for each of the first and second virtual objects can be compared to detect whether the virtual objects intersect at any locations. When an overlap is detected, process 2100 can progress to block 2106. When an overlap is not detected, process 2100 can loop back to block 2102, where the virtual objects can continue to be displayed until an overlap is detected at block 2104.

At block 2106, process 2100 can dynamically alter the display of at least one of the first virtual object or second virtual object to display an overlap indicator. For example, the overlap indicator can be displayed at the overlapping portions of the first virtual object and/or second virtual object. The overlap indicator can be an outline that spans the overlapping portion, a mask/overlay that spans the overlapping portion, a highlighting for the overlapping portion, or any other suitable indicator

In some implementations, based on the engagement, the display of the first virtual object can be altered to display the overlap indicator. In some implementations, the overlap indicator can be overlapping boundary boxes for each of the first virtual object and second virtual object, where the boundary boxes identify a boundary for each of the first virtual object and second virtual object.

At block 2108, process 2100 can determine whether one or more of the first virtual object and second virtual object are automatically moveable. For example, control parameters for one or more virtual objects (or categories of virtual objects) can be defined that indicate whether the virtual object is moveable by automated triggers. In some instances, it may be beneficial for a virtual object to be moveable manually by a user, but not moveable by automated triggers (e.g., expiration of an overlap timer), for example because some virtual objects may be optimized at precise locations.

In some implementations, the first virtual object and second virtual object may not be automatically moveable when the aggregate of display volume/area for currently displayed virtual objects in an XR environment (or portion of an XR environment) exceeds a criteria (e.g., threshold area/volume, or threshold percentage of available display area/volume). For example, in a crowded XR environment it may be beneficial to permit virtual objects to overlap and/or rely on a user's manual placement of virtual objects.

When one or more of the first virtual object and second virtual object are determined to be automatically moveable, process 2100 can progress to block 2110. When the first virtual object and second virtual object are not determined to be automatically moveable, process 2100 can loop back to block 2106. For example, if neither virtual object is automatically moveable, process 2100 cannot perform an automatic move to remedy the detected overlap, and thus the overlap indicator can continue to be displayed to notify the user of the overlap. In some implementations, if neither virtual object is automatically moveable, the first virtual object and second virtual object may be displayed without the overlap indicator.

At block 2110, process 2100 can dynamically alter a characteristic of the overlap indicator as a duration of time for the detected overlap increases. For example, as the overlap persists over time the overlap manager can alter the degree, intensity, or type of display for the overlap indicator, such as by increasing a brightness, changing a display color, increasing the width of an outline, adding a mask/overly, or any other suitable display change.

At block 2112, process 2100 can determine whether the overlap is maintained. For example, a user may manually move one or more of the overlapping objects to remedy the overlap. When the overlap is maintained, process 2100 can progress to block 2116. When the overlap is not maintained, process 2100 can progress to block 2114. At block 2114, process 2100 can display the virtual objects without the overlap indicator. Because the virtual objects no longer overlap, the overlap indicator can be omitted.

At block 2116, process 2100 can determine whether an overlap timer has expired. For example, an overlap timer can be defined that, upon expiration, causes one or more of the overlapping virtual objects to be dynamically moved. The overlap timer can be, e.g., 2 seconds, 5 seconds, 10 seconds, 15 seconds, one minute, several minutes, or any other suitable duration of time.

When the overlap timer has expired, process 2100 can progress to block 2118. When the overlap timer has not expired, process 2100 can loop back to block 2110. At block 2110, the display of the overlap indicator can continue to be altered until the overlap timer has expired.

At block 2118, process 2100 can dynamically move at least one of the first virtual object or the second virtual object. For example, one or both of the overlapping first and second virtual objects can be dynamically moved upon expiration of the overlap timer. In some implementations, the first virtual object is engaged by the user, and thus the second virtual object (non-engaged overlapping virtual object) is dynamically moved. In other examples, the engaged virtual object is dynamically moved and/or both overlapping virtual objects are dynamically moved.

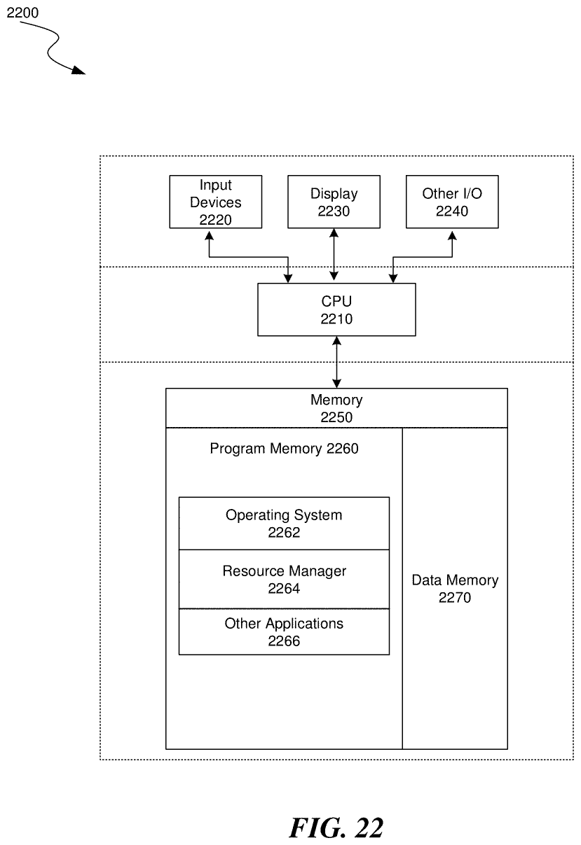

FIG. 22 is a block diagram illustrating an overview of devices on which some implementations of the disclosed technology can operate. The devices can comprise hardware components of a device 2200. Device 2200 can include one or more input devices 2220 that provide input to the Processor(s) 2210 (e.g., CPU(s), GPU(s), HPU(s), etc.), notifying it of actions. The actions can be mediated by a hardware controller that interprets the signals received from the input device and communicates the information to the processors 2210 using a communication protocol. Input devices 2220 include, for example, a mouse, a keyboard, a touchscreen, an infrared sensor, a touchpad, a wearable input device, a camera- or image-based input device, a microphone, or other user input devices.

Processors 2210 can be a single processing unit or multiple processing units in a device or distributed across multiple devices. Processors 2210 can be coupled to other hardware devices, for example, with the use of a bus, such as a PCI bus or SCSI bus. The processors 2210 can communicate with a hardware controller for devices, such as for a display 2230. Display 2230 can be used to display text and graphics. In some implementations, display 2230 provides graphical and textual visual feedback to a user. In some implementations, display 2230 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 2240 can also be coupled to the processor, such as a network card, video card, audio card, USB, firewire or other external device, camera, printer, speakers, CD-ROM drive, DVD drive, disk drive, or Blu-Ray device.

In some implementations, the device 2200 also includes a communication device capable of communicating wirelessly or wire-based with a network node. The communication device can communicate with another device or a server through a network using, for example, TCP/IP protocols. Device 2200 can utilize the communication device to distribute operations across multiple network devices.

The processors 2210 can have access to a memory 2250 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 2250 can include program memory 2260 that stores programs and software, such as an operating system 2262, resource manager 2264, and other application programs 2266. Memory 2250 can also include data memory 2270, which can be provided to the program memory 2260 or any element of the device 2200.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

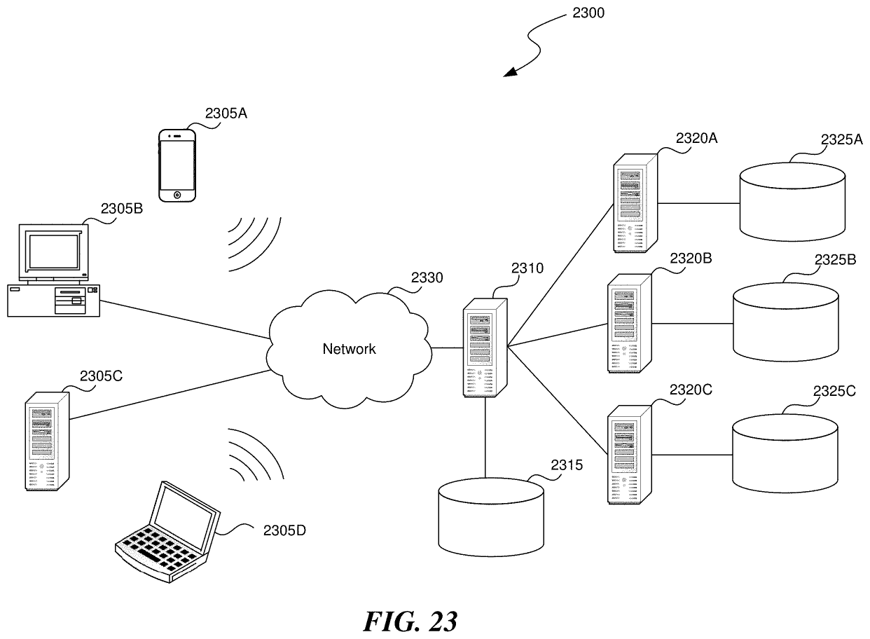

FIG. 23 is a block diagram illustrating an overview of an environment 2300 in which some implementations of the disclosed technology can operate. Environment 2300 can include one or more client computing devices 2305A-D, examples of which can include device 2200. Client computing devices 2305 can operate in a networked environment using logical connections through network 2330 to one or more remote computers, such as a server computing device.

In some implementations, server 2310 can be an edge server which receives client requests and coordinates fulfillment of those requests through other servers, such as servers 2320A-C. Server computing devices 2310 and 2320 can comprise computing systems, such as device 2200. Though each server computing device 2310 and 2320 is displayed logically as a single server, server computing devices can each be a distributed computing environment encompassing multiple computing devices located at the same or at geographically disparate physical locations. In some implementations, each server 2320 corresponds to a group of servers.

Client computing devices 2305 and server computing devices 2310 and 2320 can each act as a server or client to other server/client devices. Server 2310 can connect to a database 2315. Servers 2320A-C can each connect to a corresponding database 2325A-C. As discussed above, each server 2320 can correspond to a group of servers, and each of these servers can share a database or can have their own database. Databases 2315 and 2325 can warehouse (e.g., store) information. Though databases 2315 and 2325 are displayed logically as single units, databases 2315 and 2325 can each be a distributed computing environment encompassing multiple computing devices, can be located within their corresponding server, or can be located at the same or at geographically disparate physical locations.

Network 2330 can be a local area network (LAN) or a wide area network (WAN), but can also be other wired or wireless networks. Network 2330 may be the Internet or some other public or private network. Client computing devices 2305 can be connected to network 2330 through a network interface, such as by wired or wireless communication. While the connections between server 2310 and servers 2320 are shown as separate connections, these connections can be any kind of local, wide area, wired, or wireless network, including network 2330 or a separate public or private network.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

The disclosed technology can include, for example, the following:

A computing system for predicting a time-to-full for a battery charging session of a current battery, the system comprising: one or more processors; and one or more memories storing instructions that, when executed by the one or more processors, cause the computing system to perform a process including: computing a first part of a charge time for a constant current stage of the battery charging session; computing a second part of a charge time for a constant voltage stage of the battery charging session by applying an empirical model, generated based on experimental testing for a battery of a same type as the current battery, wherein the empirical model takes both temperature and battery life as independent variables and produces a predicted time for the portion of the battery charging session that is past a constant current/constant voltage transition point; and computing an overall predicted charging time by adding the first part to the second part.

A method for managing virtual objects displays in an XR environment, the method comprising: displaying a first virtual object and a second virtual object in the XR environment; detecting an overlap between the first virtual object and the second virtual object; dynamically altering the display of at least one of the first virtual object or second virtual object when the overlap is detected to display an overlap indicator, wherein, i) the display of the first virtual object is altered to display the overlap indicator, ii) the overlap indicator is displayed at an overlapping portion of the first virtual object or the second virtual object, or iii) any combination thereof; dynamically altering a characteristic of the overlap indicator as a duration of time for the detected overlap increases; and dynamically moving at least one of the first virtual object or the second virtual object when the duration of time for the detected overlap meets a time criteria.

I/We claim:

1. A method for running a state machine with transitions between power modes, defining active and inactive systems, according to a set of transition triggers, the method comprising:
transitioning from a low power state to a moderate power state in response to one or more of: a notification event or an assistant wake word;
transitioning from the low power state to a full-feature state in response to a wake action; and
transitioning from the moderate power state to the full-feature state in response to one or more of: a notification selection event, the wake action, or a home gesture.

2. A method for computing a model for timing a constant voltage stage of a battery charging session, the method comprising:
deriving multiple sets of data points for battery charging times across multiple cycles of charging a battery, each set having been generated at one of multiple temperatures;
determining a transition point where the battery charging session transitions from using substantially constant current to substantially constant voltage;
deriving a formula, for each temperature set of data points, by fitting a function to the portion of each data point in that set that is past the transition point; and
deriving an empirical model, from the formulas for each temperature, that takes both temperature and battery life as independent variables and produces a predicted time for the portion of the battery charging session that is past the transition point.

3. A method for dynamically displaying virtual object elements, the method comprising:
receiving, from a user, a selection for a virtual object displayed in an artificial reality environment;
detecting a two-dimensional surface proximate to the selected virtual object within the artificial reality environment, wherein an orientation for the two-dimensional surface is detected; and
displaying, in response to the selection, one or more virtual object elements for the selected virtual object, the virtual object elements comprising at least a virtual object chrome and a two-dimensional surface indicator, wherein the two-dimensional surface indicator is displayed as an area along the detected two-dimensional surface according to the detected orientation.
